(19) United States
(12) Patent Application Publication
(10) Pub. No.: US 2025/0271854 A1
(43) Pub. Date: Aug. 28, 2025

(54) NETWORK COMMUNICATION DEVICES AND METHODS FOR ROBOTIC OPERATIONS

(71) Applicant: Boston Dynamics, Inc., Waltham, MA (US)

(72) Inventors: John Aaron Saunders, Arlington, MA (US); Michael Murphy, Carlisle, MA (US); Matthew Malchano, Arlington, MA (US); Federico Vicentini, Lexington, MA (US); Guillermo Diaz-Lankenau, Santa Clara, CA (US); Christopher Lee, Arlington, MA (US)

(73) Assignee: Boston Dynamics, Inc., Waltham, MA (US)

(21) Appl. No.: 18/984,434

(22) Filed: Dec. 17, 2024

Related U.S. Application Data
(60) Provisional application No. 63/558,853, filed on Feb. 28, 2024.
(60) Provisional application No. 63/640,462, filed on Apr. 30, 2024.

(51) Int. Cl. G05D 1/226; B25J 9/16; G05D 1/622; G05D 1/69; G05D 105/28; G05D 107/70; H04L 67/12; H04W 4/33; H04W 76/15; H04W 84/12

(52) U.S. Cl. CPC G05D 1/226; G05D 1/622; G05D 1/69; H04L 67/12; H04W 4/33; H04W 76/15; B25J 9/1676; G05D 2105/28; G05D 2107/70; H04W 84/12

(57) ABSTRACT

Methods and apparatus for implementing signaling in access point devices is described. An access point device may include a network interface configured to be coupled to a wired network, a radio configured to emit radio waves that enable a plurality of wireless devices in an environment of the access point device to wirelessly access the wired network, and at least one signaling component, wherein the at least one signaling component is configured to transmit and/or receive signals, wherein the signals are different from the radio waves emitted from the radio.

### CROSS-REFERENCE TO RELATED APPLICATIONS

This application claims the benefit under 35 U.S.C. § 119(e) of U.S. Provisional Patent Application Ser. No. 63/558,853, filed Feb. 28, 2024, and entitled “NETWORK COMMUNICATION DEVICES AND METHODS FOR ROBOTIC OPERATIONS,” and claims priority to U.S. Provisional Patent Application Ser. No. 63/640,462, filed Apr. 30, 2024, and entitled “NETWORK COMMUNICATION DEVICES AND METHODS FOR ROBOTIC OPERATIONS,” the entire contents of each of which are incorporated by reference herein.

### FIELD OF THE INVENTION

This disclosure relates generally network communication, and more specifically to network communication for robotic devices in an environment.

### BACKGROUND

A wireless local area network may be provided in an environment such as a warehouse by an access point network that includes multiple access point devices positioned in fixed locations in the environment. Fleets of mobile robotic devices operating in the environment may perform various tasks, such as grasping objects (e.g., boxes) and moving them from one location to another. Physical fixed guards (e.g., fencing) and/or sensors onboard the mobile robotic devices may be used to facilitate safe operation of the mobile robotic devices when humans are also working alongside the robots in the environment.

### SUMMARY

In some embodiments, an access point device is provided. The access point device includes a network interface configured to be coupled to a wired network, a radio configured to emit radio waves that enable a plurality of wireless devices in an environment of the access point device to wirelessly access the wired network, and at least one signaling component, wherein the at least one signaling component is configured to transmit and/or receive signals, wherein the signals are different from the radio waves emitted from the radio.

In one aspect, the environment is a warehouse, and the access point device is configured as a node in a wireless local area network within the warehouse. In another aspect, the plurality of wireless devices include a plurality of mobile robots operating within the warehouse. In another aspect, the plurality of mobile robots include a first mobile robot configured to grasp and place objects in the environment. In another aspect, the objects include boxes.

In another aspect, the at least one signaling component includes a radio-frequency component configured to transmit and/or receive the signals. In another aspect, the signals include one or more of ultrawideband signals, WiFi signals, or Bluetooth signals. In another aspect, the at least one signaling component includes a RADAR system and/or a LIDAR system configured to sense a presence of mobile objects in the environment. In another aspect, the at least one signaling component includes a camera module configured to capture information in the environment of the access point device. In another aspect, the camera module includes one or more of a color camera, a depth camera, or a thermal camera. In another aspect, the at least one signaling component includes a microphone configured to detect sound waves emitted by one or more objects in the environment.

In another aspect, the access point device further includes at least one computer processor. The at least one computer processor is programmed to process at least some of the signals received by the at least one signaling component to detect and/or identify one or more objects in the environment. In another aspect, processing at least some of the signals includes processing at least some of the signals using at least one machine learning model. In another aspect, detecting one or more objects in the environment includes detecting motion of one or more objects in the environment. In another aspect, the at least one signaling component includes a plurality of signaling components, and the at least one computer processor is further programmed to detect and/or identify the one or more objects in the environment based, at least in part, on signals from multiple of the plurality of signaling components.

In another aspect, the one or more objects detected and/or identified in the environment includes a mobile agent. In another aspect, the mobile agent is a human or a mobile robot. In another aspect, the at least one computer processor is further programmed to send a signal to a central processor in response to detecting and/or identifying the one or more objects in the environment, the central processor configured to facilitate control of an operation of the mobile agent. In another aspect, the central processor is configured to facilitate control of an operation of the mobile robot. In another aspect, the at least one computer processor includes a safety rated processor configured to make safety decisions associated with the operation of the mobile agent.

In another aspect, the at least one signaling component includes a light source. In another aspect, the light source is configured to transmit a light pattern into the environment. In another aspect, the light source is configured to blink according to a particular pattern. In another aspect, the at least one signaling component includes an audio source configured to output audio into the environment. In another aspect, transmitting and/or receiving signals includes transmitting and/or receiving data using the signals.

In some embodiments, a method of operating an access point device is provided. The method includes controlling the access point device to emit radio waves that enable a plurality of wireless devices in an environment of the access point device to wirelessly access a wired network coupled to the access point device, receiving, by at least one signaling component, signals from one or more objects in the environment, processing the received signals to detect and/or identify the one or more objects in the environment, and sending a signal to a processor in response to detecting and/or identifying the one or more objects in the environment, the processor configured to facilitate control of an operation of at least one mobile robot in the environment.

In one aspect, the access point device is configured as a node in a wireless local area network within the warehouse. In another aspect, the plurality of wireless devices include a plurality of mobile robots operating within the warehouse. In another aspect, the plurality of mobile robots include a first mobile robot configured to grasp and place objects in the environment. In another aspect, the objects include boxes.

In another aspect, the received signals are second signals the method further includes transmitting, by the at least one signaling component, first signals, and the second signals are received after transmitting the first signals. In another aspect, the signals include one or more of ultrawideband signals, WiFi signals, or Bluetooth signals. In another aspect, receiving, by at least one signaling component, signals, includes receiving sound waves emitted by one or more objects in the environment. In another aspect, processing the signals includes processing at least some of the signals using at least one machine learning model. In another aspect, detecting one or more objects in the environment includes detecting motion of one or more objects in the environment. In another aspect, the at least one signaling component includes a plurality of signaling components, and the method further includes detecting and/or identifying the one or more objects in the environment based, at least in part, on signals from multiple of the plurality of signaling components.

In another aspect, the detecting and/or identifying one or more objects in the environment includes detecting and/or identifying a mobile agent. In another aspect, the mobile agent is a human or a mobile robot. In another aspect, the method further includes sending a signal to a central processor in response to detecting and/or identifying the one or more objects in the environment, the central processor configured to facilitate control of an operation of the mobile agent.

In another aspect, the mobile agent is a mobile robot, and the processor is configured to facilitate control of an operation of the mobile robot. In another aspect, the method further includes transmitting, by the at least one signaling component, light into the environment. In another aspect, transmitting light into the environment includes transmitting a light pattern into the environment. In another aspect, transmitting light into the environment includes controlling a light source of the access point device to blink according to a particular pattern. In another aspect, the method further includes outputting, by the at least one signaling component, an audio signal into the environment. In another aspect, transmitting and/or receiving signals includes transmitting and/or receiving data using the signals.

In some embodiments, a processor communicatively coupled to a plurality of access point devices positioned at fixed locations in an environment is provided. The processor is programmed to determine a location of a first mobile agent in an environment based, at least in part, on signals received from the plurality of access point devices, and facilitate control of an operation of a first mobile robot in the environment based, at least in part, on the determined location of the first mobile agent.

In one aspect, the environment is a warehouse, and the plurality of access point devices are configured as nodes in a wireless local area network within the warehouse. In another aspect, the plurality of access point devices are fixed to a ceiling of the warehouse. In another aspect, the first mobile robot is configured to grasp and place objects in the environment. In another aspect, the objects include boxes.

In another aspect, the signals received from the plurality of access point devices include information about a location of the first mobile agent relative to the first mobile robot. In another aspect, facilitating control of an operation of a first mobile robot includes instructing the first mobile robot to move slower. In another aspect, facilitating control of an operation of a first mobile robot includes instructing the first mobile robot to come to an operational stop. In another aspect, facilitating control of an operation of a first mobile robot is based, at least in part, on a distance between the determined location of the first mobile agent and the first mobile robot.

In another aspect, the processor is further programmed to identify the first mobile agent as a human or a second mobile robot, and facilitate control of the operation of the first mobile robot based on whether the first mobile agent is identified as a human or a second mobile robot. In another aspect, facilitating control of an operation of a first mobile robot includes instructing the first mobile robot to move slower and/or come to an operational stop when the first mobile agent is identified a human. In another aspect, facilitating control of an operation of a first mobile robot includes instructing the first mobile robot to move slower and/or come to an operational stop when the first mobile agent is identified as a human and when a distance between the first mobile agent and the first mobile robot is less than a threshold distance. In another aspect, the processor is a safety rated processor, and facilitating control of an operation of a first mobile robot includes facilitating control of an operation of the first mobile robot based on an output of the safety rated processor.

In another aspect, the processor is further programmed to store location information for each of the plurality of access point devices, and wherein determining a location of a mobile agent in an environment is further based, at least in part, on the stored location information. In another aspect, the processor is further programmed to receive from a second mobile agent, updated location information for a first access point device of the plurality of access point devices; and update the stored location information for the first access point device in response to receiving the updated location information. In another aspect, the second mobile agent is a second mobile robot. In another aspect, the processor is further programmed to instruct the second mobile robot to determine the updated location information for the first access point device. In another aspect, instructing the second mobile robot to determine the updated location information for the first access point device includes instructing the second mobile robot to navigate to a location in the environment and sense the updated location information for the first access point device using at least one sensor onboard the second mobile robot after navigating to the location in the environment.

In another aspect, the processor is further programmed to store a model or map of the environment, wherein the model or map of the environment includes locations of a plurality of objects in the environment. In another aspect, the processor is further programmed to update the model or map of the environment based, at least in part, on information received from the plurality of access point devices. In another aspect, the processor is further programmed to receive a query from the first mobile robot, the query including a request for safety information, wherein facilitating control of an operation of the first mobile robot includes sending a communication to the first mobile robot including the safety information, wherein the safety information is determined based, at least in part, on the model or map of the environment.

In some embodiments, a method of performing localization in an environment is provided. The method includes receiving, by a processor, signals from a plurality of access point devices positioned at fixed locations in the environment, determining, by the processor, a location of a first mobile agent in the environment based, at least in part, on the received signals, and facilitating control of an operation of a first mobile robot in the environment based, at least in part, on the determined location of the first mobile agent.

In one aspect, the environment is a warehouse, and the plurality of access point devices are configured as nodes in a wireless local area network within the warehouse. In another aspect, the plurality of access point devices are fixed to a ceiling of the warehouse. In another aspect, the first mobile robot is configured to grasp and place objects in the environment. In another aspect, the objects include boxes.

In another aspect, receiving signals from the plurality of access point devices includes receiving information about a location of the first mobile agent relative to the first mobile robot. In another aspect, facilitating control of an operation of a first mobile robot includes instructing the first mobile robot to move slower. In another aspect, facilitating control of an operation of a first mobile robot includes instructing the first mobile robot to come to an operational stop. In another aspect, facilitating control of an operation of a first mobile robot is based, at least in part, on a distance between the determined location of the first mobile agent and the first mobile robot.

In another aspect, the method further includes identifying the first mobile agent as a human or a second mobile robot, and facilitating control of the operation of the first mobile robot based on whether the first mobile agent is identified as a human or a second mobile robot. In another aspect, facilitating control of an operation of a first mobile robot includes instructing the first mobile robot to move slower and/or come to an operational stop when the first mobile agent is identified a human. In another aspect, facilitating control of an operation of a first mobile robot includes instructing the first mobile robot to move slower and/or come to an operational stop when the first mobile agent is identified as a human and when a distance between the first mobile agent and the first mobile robot is less than a threshold distance. In another aspect, the processor is a safety rated processor, and facilitating control of an operation of a first mobile robot includes facilitating control of an operation of the first mobile robot based on an output of the safety rated processor.

In another aspect, the method further includes storing location information for each of the plurality of access point devices, and wherein determining a location of a mobile agent in an environment is further based, at least in part, on the stored location information. In another aspect, the method further includes receiving from a second mobile agent, updated location information for a first access point device of the plurality of access point devices; and updating the stored location information for the first access point device in response to receiving the updated location information. In another aspect, the second mobile agent is a second mobile robot. In another aspect, the method further includes instructing the second mobile robot to determine the updated location information for the first access point device. In another aspect, instructing the second mobile robot to determine the updated location information for the first access point device includes instructing the second mobile robot to navigate to a location in the environment and sense the updated location information for the first access point device using at least one sensor onboard the second mobile robot after navigating to the location in the environment.

In another aspect, the method further includes storing a model or map of the environment, wherein the model or map of the environment includes locations of a plurality of objects in the environment. In another aspect, the method further includes updating the model or map of the environment based, at least in part, on information received from the plurality of access point devices. In another aspect, the method further includes receiving a query from the first mobile robot, the query including a request for safety information, wherein facilitating control of an operation of the first mobile robot includes sending a communication to the first mobile robot including the safety information, wherein the safety information is determined based, at least in part, on the model or map of the environment.

In some embodiments, a mobile robotic device is provided. The mobile robotic device includes a mobile base configured to navigate through an environment, and a robot controller. The robot controller is configured to control the mobile base to navigate to a particular location in the environment in response to receiving an instruction to navigate to the particular location, and perform an action associated with a local area network after navigating to the particular location.

In one aspect, the environment is a warehouse. In another aspect, the local area network is provided by a plurality of access node devices located at fixed locations in the warehouse. In another aspect, the environment includes a plurality of access point devices coupled to physical infrastructure in the environment, the plurality of access point devices providing the local area network, performing an action associated with a local area network includes determining, using at least one sensor onboard the mobile robotic device, a location of a first access point device of the plurality of access point devices, and providing the location of the first access point device to a central processor configured to perform localization of objects within the environment.

In another aspect, the mobile robotic device further includes an odometry system configured to determine a location of the mobile robotic device, the odometry system being associated with the at least one sensor, wherein determining, using at least one sensor onboard the mobile robotic device, a location of a first access point device includes determining the location of the first access point device based, at least in part, on an output of the odometry system. In another aspect, the at least one sensor onboard the mobile robotic device includes at least one LIDAR sensor, and determining, using at least one sensor onboard the mobile robotic device, a location of a first access point device includes determining the location of the first access point device based, at least in part, on the at least one LIDAR sensor.

In another aspect, the mobile robotic device further includes an access point device configured as a node in the local area network, and performing an action associated with the local area network includes using the access point device to provide a wireless network signal to one or more network enabled devices in the environment. In another aspect, the one or more network enabled devices includes another mobile robotic device. In another aspect, the mobile robotic device further includes a network interface configured to connect to a network other than the local area network, wherein using the access point device to provide a wireless network signal to one or more network enabled devices in the environment includes configuring the access point device to establish a network connection device to the network other than the local area network via the network interface. In another aspect, the network other than the local area network includes a cellular network. In another aspect, the cellular network is an LTE network.

In some embodiments, a method of using a mobile robotic device to perform an action associated with a local area network is provided. The method includes instructing a mobile robotic device to navigate to a particular location in an environment in response to receiving an instruction to navigate to the particular location, and instructing the mobile robotic device to perform an action associated with a local area network after navigating to the particular location.

In one aspect, the environment is a warehouse. In another aspect, the local area network is provided by a plurality of access node devices located at fixed locations in the warehouse. In another aspect, the environment includes a plurality of access point devices coupled to physical infrastructure in the warehouse, the plurality of access point devices providing the local area network, performing an action associated with a local area network includes determining, using at least one sensor onboard the mobile robotic device, a location of a first access point device of the plurality of access point devices, and providing the location of the first access point device to a central processor configured to perform localization of objects within the warehouse.

In another aspect, the method further includes determining, with an odometry system of the mobile robotic device, a location of the mobile robotic device, the odometry system being associated with the at least one sensor, wherein determining, using at least one sensor onboard the mobile robotic device, a location of a first access point device includes determining the location of the first access point device based, at least in part, on an output of the odometry system. In another aspect, the at least one sensor onboard the mobile robotic device includes at least one LIDAR sensor, and determining, using at least one sensor onboard the mobile robotic device, a location of a first access point device includes determining the location of the first access point device based, at least in part, on the at least one LIDAR sensor.

In another aspect, performing an action associated with the local area network includes using an access point device onboard the mobile robotic device to provide a wireless network signal to one or more network enabled devices in the environment. In another aspect, the one or more network enabled devices includes another mobile robotic device. In another aspect, using the access point device to provide a wireless network signal to one or more network enabled devices in the environment includes configuring the access point device to establish a network connection device to a network other than the local area network. In another aspect, the network other than the local area network includes a cellular network. In another aspect, the cellular network is an LTE network.

In some embodiments, a system configured to provide a local area network in an environment is provided. The system includes a plurality of first access point devices positioned in fixed locations in the environment, the plurality of first access point devices configured as first nodes in the local area network, a second access point device coupled to a mobile robotic device in the environment, the second access point device configured as a second node in the local area network; and a processor configured to instruct the mobile robotic device to navigate to a location in the environment and perform an action associated with the local area network.

In some embodiments, a method of monitoring a region in an environment is provided. The method includes projecting one or more light patterns onto a surface in the environment, receiving one or more images of a monitored region that includes the one or more light patterns, detecting based, at least in part, on the one or more images, an obstacle in the monitored region, and providing an indication of the obstacle to a mobile robot in a vicinity of the monitored region.

In one aspect, projecting one or more light patterns comprises projecting a grid of lines onto a ground surface of the environment. In another aspect, detecting an obstacle in the monitored region comprises detecting a disturbance in a spacing between at least two lines in the grid of lines. In another aspect, receiving one or more images comprises receiving a first image captured at a first time and a second image captured at a second time after the first time, and detecting an obstacle in the monitored region comprises detecting a change between the first image and the second image. In another aspect, the detecting is performed by a central processing system, and providing an indication of the obstacle to the mobile robot comprises providing a wireless signal from the central processing system to an onboard safety system of the mobile robot. In another aspect, the mobile robot is configured to change an operation of the mobile robot in response to receiving the indication of the obstacle in the monitored region. In another aspect, the method further includes controlling the mobile robot to change on operation of the mobile robot in response to receiving the indication of the obstacle in the monitored region.

In some embodiments, a method of monitoring a blind spot in an onboard safety system of a mobile robot is provided. The method includes receiving, from at least one off-robot sensor, an indication of whether a blind spot in an onboard safety system of a mobile robot is clear of entities of interest, and performing an operation of the mobile robot based, at least in part, on the indication and information from the onboard safety system of the mobile robot.

In one aspect, the method further includes identifying a presence of the blind spot in the onboard safety system of the mobile robot, and receiving the indication of whether the blind spot is clear of entities of interest when the presence of the blind spot is identified. In another aspect, identifying the presence of the blind spot includes sensing a tag fixed to infrastructure at a location near a current location of the mobile robot, and identifying the presence of the blind spot based, at least in part, on the tag. In another aspect, identifying the presence of the blind spot comprises analyzing data from the onboard safety system of the mobile robot to determine the presence and/or a location of the blind spot. In another aspect, performing an operation of the mobile robot based, at least in part, on the indication and information from the onboard safety system of the mobile robot comprises limiting an operation of the mobile robot when the indication indicates that an entity of interest is present in the blind spot. In another aspect, limiting an operation of the mobile robot includes limiting a speed and/or trajectory of one or more components of the mobile robot. In another aspect, performing an operation of the mobile robot based, at least in part, on the indication and information from the onboard safety system of the mobile robot comprises resuming a desired operation of the mobile robot when the indication indicates that an entity of interest is not present in the blind spot.

In another aspect, the at least one off-robot sensor includes an off-robot sensor fixed to infrastructure of an environment in which the mobile robot is located. In another aspect, the off-robot sensor is included as a sensing component in a network access point device. In another aspect, the at least one off-robot sensor includes a moveable off-robot sensor placed at a location near the blind spot. In another aspect, the moveable off-robot sensor is coupled to another mobile robot. In another aspect, receiving an indication of whether a blind spot in an onboard safety system of a mobile robot is clear of entities of interest comprises receiving the indication from a central processing system within an environment in which the mobile robot is located. In another aspect, receiving an indication of whether a blind spot in an onboard safety system of a mobile robot is clear of entities of interest comprises receiving the indication from the at least one off-robot sensor. In another aspect, receiving an indication of whether a blind spot in an onboard safety system of a mobile robot is clear of entities of interest comprises receiving the indication from another mobile robot in wireless communication with the mobile robot. In another aspect, the entities of interest include a human.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIGS. 1A and 1B are perspective views of a robot, according to an illustrative embodiment of the invention.

FIG. 2A depicts robots performing different tasks within a warehouse environment, according to an illustrative embodiment of the invention.

FIG. 2B depicts a robot unloading boxes from a truck and placing them on a conveyor belt, according to an illustrative embodiment of the invention.

FIG. 2C depicts a robot performing an order building task in which the robot places boxes onto a pallet, according to an illustrative embodiment of the invention.

FIG. 3 is a network architecture for providing a local area network, according to an illustrative embodiment of the invention.

FIG. 4 is a flowchart of a process for using an access point device to sense one or more objects in an environment, according to an illustrative embodiment of the invention.

FIG. 5 is a flowchart of a process for controlling an operation of a mobile robot based on signals sensed by one or more access point devices, according to an illustrative embodiment of the invention.

FIG. 6 is a flowchart of a process for controlling a mobile robotic device to perform an action associated with a local area network, according to an illustrative embodiment of the invention.

FIG. 7A depicts a process of using one or more projected light patterns to perform safety monitoring, according to an illustrative embodiment of the invention.

FIG. 7B depicts a system for performing safety monitoring, according to an illustrative embodiment of the invention.

FIG. 8 is a flowchart of a process for using a projected light pattern to perform safety monitoring, according to an illustrative embodiment of the invention.

FIG. 9 depicts a blind corner scenario for a mobile robot operating in a warehouse, according to an illustrative embodiment of the invention.

FIG. 10 depicts use of a fixed sensor to monitor a blind spot area of a mobile robot, according to an illustrative embodiment of the invention.

FIG. 11 depicts use of a sensor mounted on a mobile asset to monitor a blind spot area of a mobile robot, according to an illustrative embodiment of the invention.

FIG. 12 depicts coordination between two mobile robots to perform safety monitoring, according to an illustrative embodiment of the invention.

FIGS. 13A-13C depict scenarios for using off-robot sensors to monitor a blind spot of a mobile robot traversing stairs, according to an illustrative embodiment of the invention.

FIG. 14 is a flowchart of a process for monitoring a blind spot of a mobile robot using one or more off-robot sensors, according to an illustrative embodiment of the invention.

FIG. 15 illustrates an example configuration of a robotic device, according to an illustrative embodiment of the invention.

### DETAILED DESCRIPTION

Fleets of robots may navigate large spaces, such as warehouses, that may include people and other robots. During operation, mobile robots can be hazardous to certain types of entities in the environment (e.g., humans or other robots). For example, mobile manipulator robots that are large and powerful enough to move packages from one location to another at high speeds can be dangerous to operators or other workers nearby. In such settings, mobile robots should have systems that protect entities of concern in the environment, e.g., by making sure that they are not dangerously close to the entities while operating at high speeds. As used herein the term “entities of interest” may refer to humans and/or objects (e.g., vehicles, other robots) that may move through a monitored area of a mobile robot. Other stationary objects including, but not limited to, environment infrastructure (e.g., walls, shelving, floor) that exist in a workspace of a mobile robot may not be considered “entities of interest” to the extent that motion of such objects into a monitored region of the mobile robot need not be considered.

In some situations, physical guarding systems can help serve the need to safeguard robot operation. One such system includes a cage comprised of one or more panels, which can surround the robot during operation and/or be configured to move with the robot (e.g., from one bay to another in a warehouse). Cage systems can prevent entities of concern from entering and/or a robot from leaving the robot's work zone. Another system includes one or more curtains that can be used to define boundaries of the work zone and/or shut down a robot if entities of concern breach the boundaries. However, physical guarding systems can suffer from multiple drawbacks, including but not limited to (i) taking up significant valuable space in the warehouse; (ii) interfering with operations in the warehouse, particularly in activity-dense environments (e.g., loading docks); and/or (iii) making it difficult to move and/or reconfigure boundaries (e.g., in shared spaces).

In some situations, virtual guarding systems that use sensors, such as LIDAR sensors located onboard the mobile robot may be used to provide self-safeguarding for a mobile robot. In such systems, the onboard sensors may track some entities of interest (e.g., people) approaching the robot within the environment, though they do not typically track the location of the robot itself or other robots in the environment. Accordingly, virtual guarding systems may be configured to implement conservative reactions to the presence of people in the vicinity of the robot, which may slow down operation of the robot.

Understanding the location of entities of interest (e.g., robots and people) within environments in which mobile robots are operating can be challenging, especially when localization needs to be trusted for safety purposes. For example, robots that implement virtual guarding solutions may not have line of sight to self-safeguard and work at efficient speeds. For example, when working at the end of an aisle in a warehouse, sensors onboard the robot may not be able to sense the presence of entities of interest around corners or other “blind spots” that the robot's sensor system cannot sense. Additionally, reliable and consistent communication across large workspaces can be challenging to create and maintain.

Some embodiments of the present disclosure relate to techniques for using components other than those onboard a mobile robot to participate in sensing, safety evaluation, and/or localization of entities of interest in an environment in which the mobile robot is operating. For example, as discussed in more detail below, access point devices positioned at fixed locations in the environment and configured to operate as nodes in a local area network may include signaling components that may be used to track the location of robots, people and other entities of interest in the environment. Additionally, access point devices located onboard mobile robots may participate as nodes in the local area network to provide network coverage in regions of the environment with poor coverage provided by fixed location access point devices, to provide network access failover in the event of loss of the primary local area network, and/or to perform safety monitoring of areas in the environment.

Robots can be configured to perform a number of tasks in an environment in which they are placed. Exemplary tasks may include interacting with objects and/or elements of the environment. Notably, robots are becoming popular in warehouse and logistics operations. Before robots were introduced to such spaces, many operations were performed manually. For example, a person might manually unload boxes from a truck onto one end of a conveyor belt, and a second person at the opposite end of the conveyor belt might organize those boxes onto a pallet. The pallet might then be picked up by a forklift operated by a third person, who might drive to a storage area of the warehouse and drop the pallet for a fourth person to remove the individual boxes from the pallet and place them on shelves in a storage area. Some robotic solutions have been developed to automate many of these functions. Such robots may either be specialist robots (i.e., designed to perform a single task or a small number of related tasks) or generalist robots (i.e., designed to perform a wide variety of tasks). To date, both specialist and generalist warehouse robots have been associated with significant limitations.

For example, because a specialist robot may be designed to perform a single task (e.g., unloading boxes from a truck onto a conveyor belt), while such specialized robots may be efficient at performing their designated task, they may be unable to perform other related tasks. As a result, either a person or a separate robot (e.g., another specialist robot designed for a different task) may be needed to perform the next task(s) in the sequence. As such, a warehouse may need to invest in multiple specialized robots to perform a sequence of tasks, or may need to rely on a hybrid operation in which there are frequent robot-to-human or human-to-robot handoffs of objects.

In contrast, while a generalist robot may be designed to perform a wide variety of tasks (e.g., unloading, palletizing, transporting, depalletizing, and/or storing), such generalist robots may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible.

Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task.

In such systems, the mobile base and the manipulator may be regarded as effectively two separate robots that have been joined together. Accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while certain limitations arise from an engineering perspective, additional limitations must be imposed to comply with safety regulations. For example, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not threaten the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, a highly integrated mobile manipulator robot with system-level mechanical design and holistic control strategies between the manipulator and the mobile base may provide certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

### Example Robot Overview

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

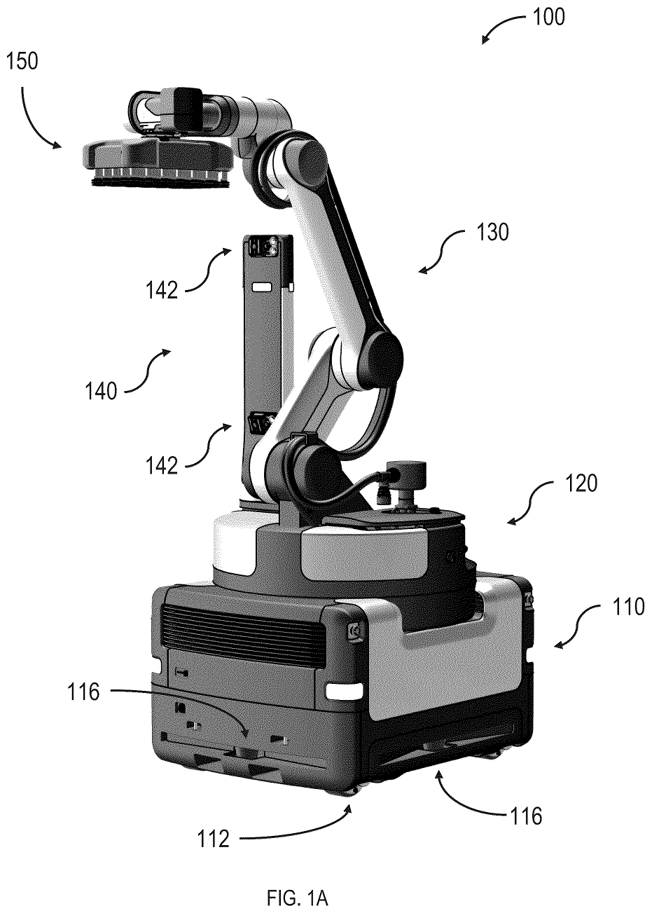

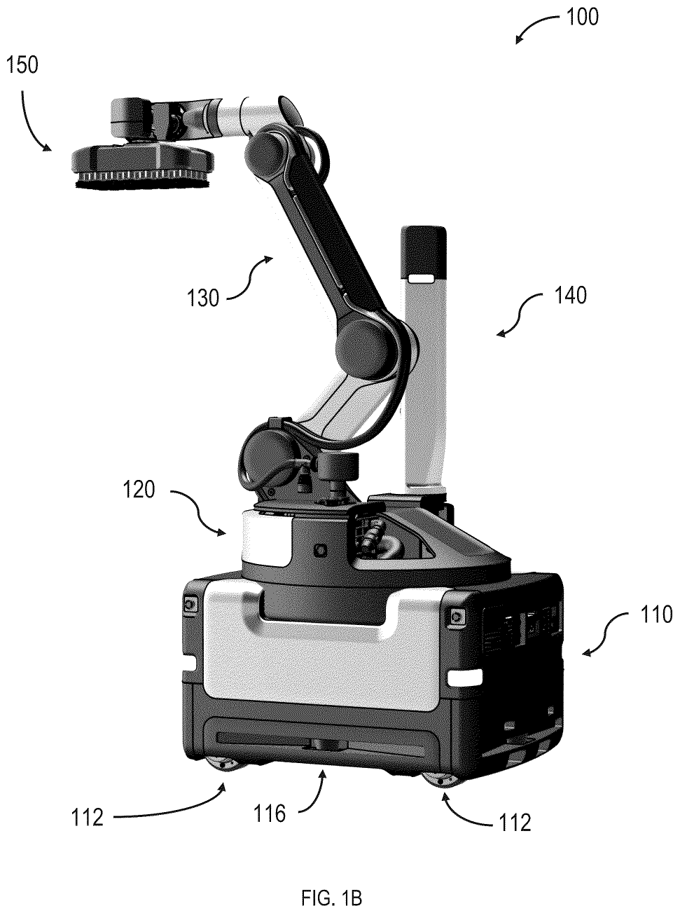

FIGS. 1A and 1B are perspective views of a robot 100, according to an illustrative embodiment of the invention. The robot 100 includes a mobile base 110 and a robotic arm 130. The mobile base 110 includes an omnidirectional drive system that enables the mobile base to translate in any direction within a horizontal plane as well as rotate about a vertical axis perpendicular to the plane. Each wheel 112 of the mobile base 110 is independently steerable and independently drivable. The mobile base 110 additionally includes a number of distance sensors 116 that assist the robot 100 in safely moving about its environment. The robotic arm 130 is a 6 degree of freedom (6-DOF) robotic arm including three pitch joints and a 3-DOF wrist. An end effector 150 is disposed at the distal end of the robotic arm 130. The robotic arm 130 is operatively coupled to the mobile base 110 via a turntable 120, which is configured to rotate relative to the mobile base 110. In addition to the robotic arm 130, a perception mast 140 is also coupled to the turntable 120, such that rotation of the turntable 120 relative to the mobile base 110 rotates both the robotic arm 130 and the perception mast 140. The robotic arm 130 is kinematically constrained to avoid collision with the perception mast 140. The perception mast 140 is additionally configured to rotate relative to the turntable 120, and includes a number of perception modules 142 configured to gather information about one or more objects in the robot's environment. The integrated structure and system-level design of the robot 100 enable fast and efficient operation in a number of different applications, some of which are provided below as examples.

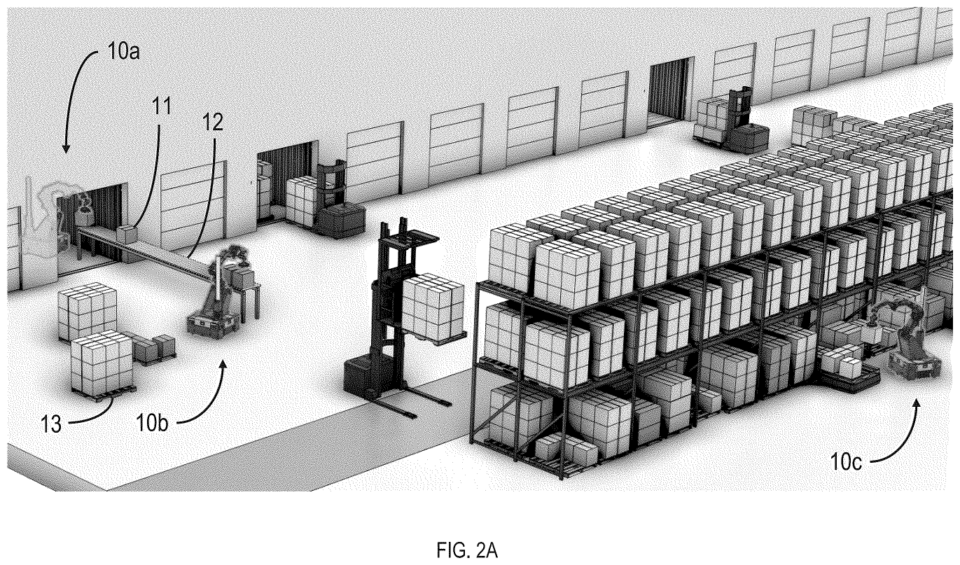

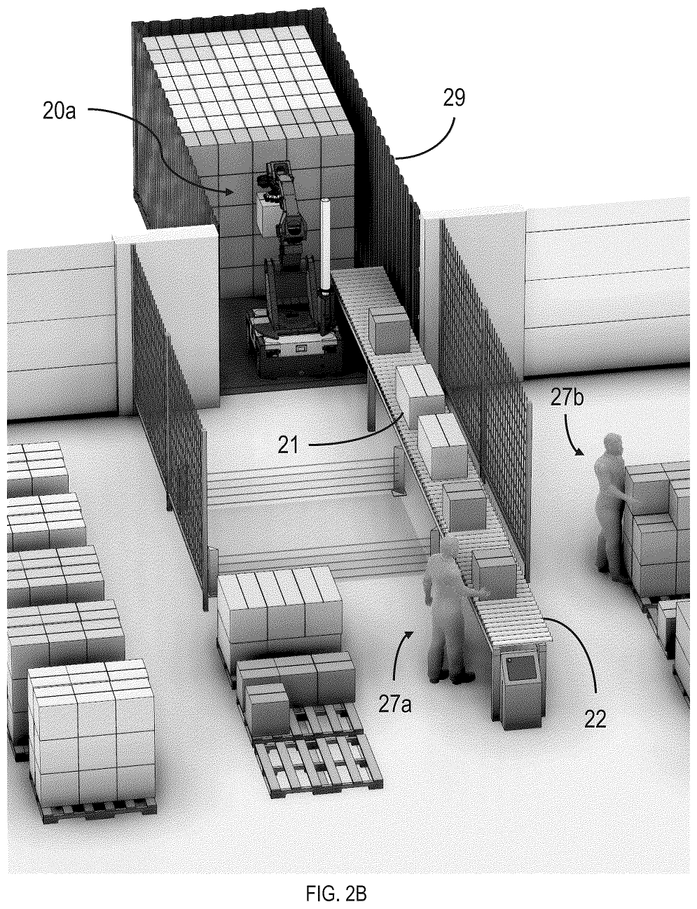

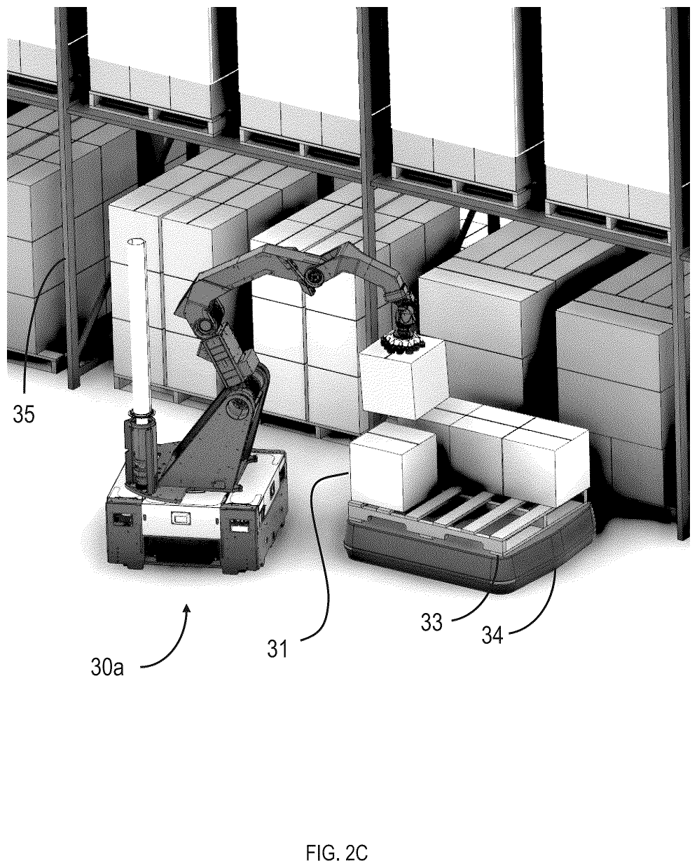

FIG. 2A depicts robots 10a, 10b, and 10c performing different tasks within a warehouse environment. A first robot 10a is inside a truck (or a container), moving boxes 11 from a stack within the truck onto a conveyor belt 12 (this particular task will be discussed in greater detail below in reference to FIG. 2B). At the opposite end of the conveyor belt 12, a second robot 10b organizes the boxes 11 onto a pallet 13. In a separate area of the warehouse, a third robot 10c picks boxes from shelving to build an order on a pallet (this particular task will be discussed in greater detail below in reference to FIG. 2C). The robots 10a, 10b, and 10c can be different instances of the same robot or similar robots. Accordingly, the robots described herein may be understood as specialized multi-purpose robots, in that they are designed to perform specific tasks accurately and efficiently, but are not limited to only one or a small number of tasks.

FIG. 2B depicts a robot 20a unloading boxes 21 from a truck 29 and placing them on a conveyor belt 22. In this box picking application (as well as in other box picking applications), the robot 20a repetitiously picks a box, rotates, places the box, and rotates back to pick the next box. Although robot 20a of FIG. 2B is a different embodiment from robot 100 of FIGS. 1A and 1B, referring to the components of robot 100 identified in FIGS. 1A and 1B will ease explanation of the operation of the robot 20a in FIG. 2B.

During operation, the perception mast of robot 20a (analogous to the perception mast 140 of robot 100 of FIGS. 1A and 1B) may be configured to rotate independently of rotation of the turntable (analogous to the turntable 120) on which it is mounted to enable the perception modules (akin to perception modules 142) mounted on the perception mast to capture images of the environment that enable the robot 20a to plan its next movement while simultaneously executing a current movement. For example, while the robot 20a is picking a first box from the stack of boxes in the truck 29, the perception modules on the perception mast may point at and gather information about the location where the first box is to be placed (e.g., the conveyor belt 22). Then, after the turntable rotates and while the robot 20a is placing the first box on the conveyor belt, the perception mast may rotate (relative to the turntable) such that the perception modules on the perception mast point at the stack of boxes and gather information about the stack of boxes, which is used to determine the second box to be picked. As the turntable rotates back to allow the robot to pick the second box, the perception mast may gather updated information about the area surrounding the conveyor belt. In this way, the robot 20a may parallelize tasks which may otherwise have been performed sequentially, thus enabling faster and more efficient operation.

Also of note in FIG. 2B is that the robot 20a is working alongside humans (e.g., workers 27a and 27b). Given that the robot 20a is configured to perform many tasks that have traditionally been performed by humans, the robot 20a is designed to have a small footprint, both to enable access to areas designed to be accessed by humans, and to minimize the size of a safety field around the robot (e.g., into which humans are prevented from entering and/or which are associated with other safety controls, as explained in greater detail below).

FIG. 2C depicts a robot 30a performing an order building task, in which the robot 30a places boxes 31 onto a pallet 33. In FIG. 2C, the pallet 33 is disposed on top of an autonomous mobile robot (AMR) 34, but it should be appreciated that the capabilities of the robot 30a described in this example apply to building pallets not associated with an AMR. In this task, the robot 30a picks boxes 31 disposed above, below, or within shelving 35 of the warehouse and places the boxes on the pallet 33. Certain box positions and orientations relative to the shelving may suggest different box picking strategies. For example, a box located on a low shelf may simply be picked by the robot by grasping a top surface of the box with the end effector of the robotic arm (thereby executing a “top pick”). However, if the box to be picked is on top of a stack of boxes, and there is limited clearance between the top of the box and the bottom of a horizontal divider of the shelving, the robot may opt to pick the box by grasping a side surface (thereby executing a “face pick”).

To pick some boxes within a constrained environment, the robot may need to carefully adjust the orientation of its arm to avoid contacting other boxes or the surrounding shelving. For example, in a typical “keyhole problem”, the robot may only be able to access a target box by navigating its arm through a small space or confined area (akin to a keyhole) defined by other boxes or the surrounding shelving. In such scenarios, coordination between the mobile base and the arm of the robot may be beneficial. For instance, being able to translate the base in any direction allows the robot to position itself as close as possible to the shelving, effectively extending the length of its arm (compared to conventional robots without omnidirectional drive which may be unable to navigate arbitrarily close to the shelving). Additionally, being able to translate the base backwards allows the robot to withdraw its arm from the shelving after picking the box without having to adjust joint angles (or minimizing the degree to which joint angles are adjusted), thereby enabling a simple solution to many keyhole problems.

The tasks depicted in FIGS. 2A-2C are only a few examples of applications in which an integrated mobile manipulator robot may be used, and the present disclosure is not limited to robots configured to perform only these specific tasks. For example, the robots described herein may be suited to perform tasks including, but not limited to: removing objects from a truck or container; placing objects on a conveyor belt; removing objects from a conveyor belt; organizing objects into a stack; organizing objects on a pallet; placing objects on a shelf; organizing objects on a shelf; removing objects from a shelf; picking objects from the top (e.g., performing a “top pick”); picking objects from a side (e.g., performing a “face pick”); coordinating with other mobile manipulator robots; coordinating with other warehouse robots (e.g., coordinating with AMRs); coordinating with humans; and many other tasks.

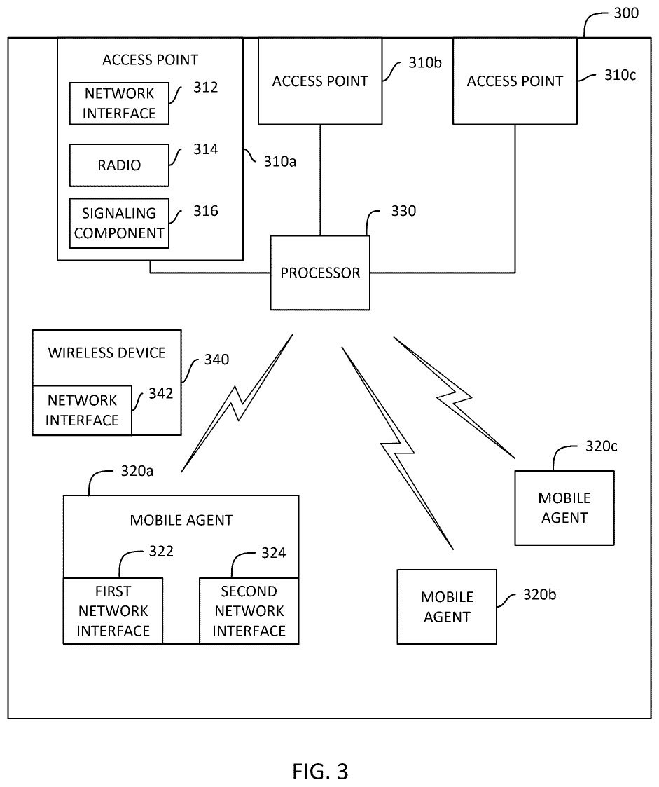

FIG. 3 illustrates an example environment 300 in which one or more mobile robots may operate, according to an illustrative embodiment of the invention. Environment 300 may include a plurality of access point devices fixed to physical infrastructure (e.g., ceilings, walls, shelving, etc.) in the environment. For instance, the plurality of access point devices may include access point device 310a, access point device 310b, and access point device 310c, each of which may be mounted to the ceiling or other similar structure of a warehouse. Collectively, the plurality of access point devices may be configured to provide a local area network (e.g., a wireless local area network) within environment 300 that wireless devices in environment 300 may use for communication. Environment 300 may also include a processor 330 communicatively coupled to each of the plurality of access point devices. Processor 330 may also be communicatively coupled to a plurality of mobile agents (e.g., a fleet of mobile robots) in environment 300. For instance, the plurality of mobile agents may include mobile agent 320a, mobile agent 320b, and mobile agent 320c, each of which may be performing operations within environment 300. Environment 300 may further include one or more wireless-enabled devices (e.g., smartphones, laptop computers, etc.) that may be configured to communicate via the local area network provided by the plurality of access point devices. For instance, the one or more wireless-enabled devices may include wireless device 340 including a network interface 342 configured to enable wireless device 340 to have network communication via the local area network.

As shown in FIG. 3, access point device 310a may include a network interface 312 configured to be coupled to a wired network (e.g., an Ethernet network) that provides access to other networks (e.g., other local area networks, a wide area network, etc.). Access point device 310a may also include a radio 314 configured to emit radio waves that enables wireless devices in environment 300 to communicatively couple to the wired network via network interface 312. In some embodiments, the radio waves emitted by radio 314 may be emitted in accordance with the WiFi standard or any other suitable wireless networking standard. Although not shown in FIG. 3, access point device 310b and access point device 310c may include network interface and radio components similar to those shown and described for access point device 310a. In some embodiments, the plurality of access point devices may be positioned sufficiently distant from each other to provide wireless local area network coverage for all or a large portion of the environment 300.

In some embodiments, one or more of the plurality of access point devices may be configured to have signaling/sensing capabilities in addition to being configured as nodes in a wireless local area network. For example, access point device 310a may include signaling component 316 configured to transmit and/or receive signals (e.g., from one or more mobile agents including mobile robots or humans) in the environment 300. Although only access point device 310a is shown as having a signaling component 316, it should be appreciated that other access point devices (e.g., access point devices 310b, 310c) may also include a signaling component, which may be the same or different as signaling component 316 in access point device 310a. In some embodiments, signaling component 316 may include components configured to transmit and/or receive different signals (e.g., a thermal camera configured to capture thermal images and a speaker configured to output an audio signal). In some embodiments, at least some access point devices in environment 300 may be configured with different sensors and/or capabilities. In some embodiments, the sensing capabilities of one or more access point devices in environment 300 may be selected based, at least in part, on a characteristic of the environment and/or one or more objects to be sensed in environment. For example, if environment 300 is a warehouse in which the temperature of the floor is similar to the temperature of humans or other mobile agents in the environment, thermal imaging as a part of sensor component 316 may have limited utility for discriminating humans from other objects in such an environment.

The signals transmitted and/or received by signaling component 316 may be different than the radio waves emitted by radio 314 to provide wireless local area network access. In some embodiments, the signaling component 316 may be configured to transmit and/or receive electromagnetic signals, examples of which include, but are not limited to, radio frequency (RF) signals, ultrawideband signals, WiFi signals, Bluetooth signals, infrared signals, or visible light signals (e.g., visible light patterns). In some embodiments, signals transmitted by signaling component 316 may be sensed by one or more objects (e.g., one or more mobile robots) in environment 300. For instance, the signaling component 316 in each of the plurality of access points may be configured to transmit light such that the object(s) in the environment can detect the transmitted light. In some embodiments, signaling component 316 may be configured to transmit audio signals (e.g., one or more tones) that can be sensed by one or more objects in the environment. In response to detecting the transmitted signals from signaling component 316, one or more objects in the environment may be configured to perform an action (e.g., a stop operation).

In some embodiments, signaling component 316 may be configured to sense the presence of one or more objects in the environment. For example, signaling component 316 may include a RADAR component and/or a LIDAR component configured to sense the presence of one or more objects in environment 300 by emitting signals and detecting reflections of the signals from the one or more objects. Additionally or alternatively, signaling component 316 may include a camera module configured to capture information in the environment 300. Non-limiting examples of cameras that may be included in a camera module in accordance with some embodiments include a color camera (e.g., an RGB camera) a depth camera, or a thermal camera. Additionally or alternatively, signaling component 316 may include one or more microphones (e.g., a microphone array) configured to detect sound waves emitted by one or more objects in the environment 300.

Sensor data sensed by signaling component 316 may be used for localization of one or more objects in environment 300 and/or for ensuring safe operation of one or more mobile robots in environment 300 in accordance with some embodiments. For instance, when a human is detected as being less than a threshold distance away from a mobile robot operating at full speed, the mobile robot may be commanded to slow down or stop operation to ensure safety of the human in its vicinity. Although a mobile robot may include an onboard safety system (e.g., one or more sensors configured to detect entities of interest near the robot), the inventors have recognized and appreciated that safe operation of mobile robots in a warehouse may be improved by using off-robot sensing capabilities, examples of which are described herein.

In some embodiments, access point device 310a may include processing resources (e.g., one or more computer processors, storage resources, communications resources, etc.) configured to process at least some of the signals received by signaling component 316. In some embodiments, at least some of the processing resources onboard the access point device 310a may include safety-rated processing resources (e.g., safety-rated hardware, software, communications components, etc.). For example, access point device 310a may include at least one computer processor configured to detect and/or identify one or more entities of interest (e.g., humans, mobile robots (autonomous mobile robots, mobile manipulator robots, etc.), forktrucks or other vehicles, etc.) in environment 300. Detecting and/or identifying one or more entities of interest may be performed in any suitable way. For instance, the received signals may be processed using a machine learning model trained to identify humans in the environment 300. At least one computer processor included in an access point device may be configured to detect motion of entities of interest in the environment based, at least in part, on the signals.

In some embodiments, multiple types of signals (e.g., image data and RF data) received by signaling component 316 may be processed to detect and/or identify entities of interest in the environment. Data from multiple types of signals may be combined in any suitable way. For industrial safety applications, it may be important to ensure that detected entities of interest are identified with high confidence. For instance, in one example, signaling component 316 may include a RADAR/LIDAR system, a thermal imager and an RGB camera, and signals from these components may be used to identify an object in the environment 300 as a human. In such an example, the RADAR/LIDAR system may be used to detect a likely human, a thermal image from the thermal imager may be used to detect the heat signature typical of a human, and a trained machine learning model may be used to process an image captured by the RGB camera or a series of images captured by the RGB camera to determine that the shape of the object and/or the object's gait is likely to be a human. Collectively, the outputs of these analyses may be used to determine with high confidence that the detected object is a human and that appropriate action (e.g., controlling an operation of one or more mobile robots near the human) should be taken. In some embodiments, signaling component 316 may be configured to send and/or receive data encoded in the transmitted and/or received signals.

In some embodiments, at least some of the signals received by signaling component 316 in access point device 310a may be processed using processing resources external to, but in communication with, access point device 310a. For example, as described above, environment 300 may include processor 330 in communication with each of access point devices 310a, 310b and 310c. In some embodiments, processor 330 may be configured to coordinate control of one or more operations performed by one or more mobile agents (e.g., one or more mobile robots) in environment 300. For instance, as shown in FIG. 3, environment 300 includes a plurality of mobile agents including mobile agent 320a, 320b, and 320c. As an example, the mobile agents may be mobile robots operating in a warehouse environment to move boxes or other objects (e.g., for truck unloading, order building, pallet unloading, etc.) within the warehouse environment. Processor 330 may be configured to wirelessly communicate with each of the mobile agents to coordinate control of an operation of a respective mobile agent and/or to provide safety information to the mobile agents.

In some embodiments, processor 330 may be configured to maintain a model or map of environment 300 including objects (e.g., infrastructure, humans, mobile robots, other mobile machinery) located therein. Processor 330 may be configured to update its model/map of the environment based, at least in part, on information received from the plurality of access point devices (e.g., access point devices 310a, 310b, 310c).

In some embodiments, processor 330 may be configured to directly control an operation of one or more mobile robots in environment 300. For instance, processor 330 may be implemented as an industrial robot controller configured to control one or more joints of the mobile robots by issuing control commands to one or more controllers onboard the mobile robots. In other embodiments, processor 330 may be configured to indirectly control an operation of one or more mobile robots in environment 300. For instance, processor 330 may be configured to receive queries from the mobile robots in the environment, with the queries requesting operating parameter information for the mobile robots at their current locations. As an example, a mobile robot may query processor 330 to determine whether it is safe to operate at its current location and processor 330 may respond to the query based, at least in part, on its stored model/map of environment 300. In some embodiments, the response may be a binary decision about whether the mobile robot should operate or come to an operational stop. For instance, when processor 330 determines based on its model/map that it is not safe for the mobile robot to operate, processor 330 may issue an emergency stop (and/or “protective stop”) signal to the mobile robot. An emergency stop mechanism is a safety feature (e.g., a switch, button, and/or associated electrical circuit) used to shut off machinery quickly in an emergency (e.g., outside the machine's normal means of powering down, which may be referred to as an “operational stop”). In response to receiving the emergency stop signal from processor 330, the mobile robot may use an emergency stop mechanism to come to an operational stop.

In some embodiments, the response may provide additional information beyond a simple yes/no decision about whether it is safe for a mobile robot to operate. For example, such additional information may include information about the proximity of a human or other object to the mobile robot or operational details regarding a safe operation speed and/or behavior of the mobile robot. The mobile robot may use the additional information to control one or more aspects of its operation, examples of which include, but are not limited to, slowing or restricting its movements, using its perception sensors to capture an image of one or more objects in proximity to the mobile robot, or performing some other action.

In embodiments in which processing resources external to access point device 310a (e.g., processor 330) are used to process signals (or data derived from signals), access point device 310a may be configured to send data to the external processing resources. For instance, access point device 310a may be configured to detect and/or identify one or more entities of interest in the environment, and in response to detecting and/or identifying one or more entities of interest, access point device 310a may be configured to send a signal to processor 330 to perform localization of the one or more detected entities of interest (e.g., humans, mobile robots, etc.) in the environment.

In some embodiments, processor 330 includes a safety-rated processor configured to output safety-rated decisions about operations of one or more mobile agents in environment 300. In some embodiments, signaling component 316 in access point device 310a may be configured to detect motion in the environment 300 (e.g., using a background subtraction technique) and may send a signal to processor 330 in response to detecting movement. For example, in some embodiments, an image of a ground surface of environment 300 as sensed by the signaling component 316 of one or more access point devices may be compared at multiple time points to identify an object in the environment. For instance, if the image of the ground surface looks like clear ground and matches exactly (or similarly enough) to what was observed previously, a binary yes/no decision about identifying entities of interest in the environment may be made. In other embodiments, information from multiple sensor data streams may be processed (e.g., using statistical methods) and a combination of the multiple processed sensor data streams may be used to identify entities of interest (e.g., humans in environment 300). Sensor data from multiple different types of sensors may be combined in any suitable way. For instance, in some embodiments multiple sensor data streams received synchronously or asynchronously may be combined using sensor fusion techniques (e.g., using Kalman filters, factor graphs, etc.), and the combined output may be used to identify one or more entities of interest in the environment. In some embodiments, the multiple sensor data streams may be weighted differently, for example, depending on a level of confidence, a level of importance to the task being performed, etc.

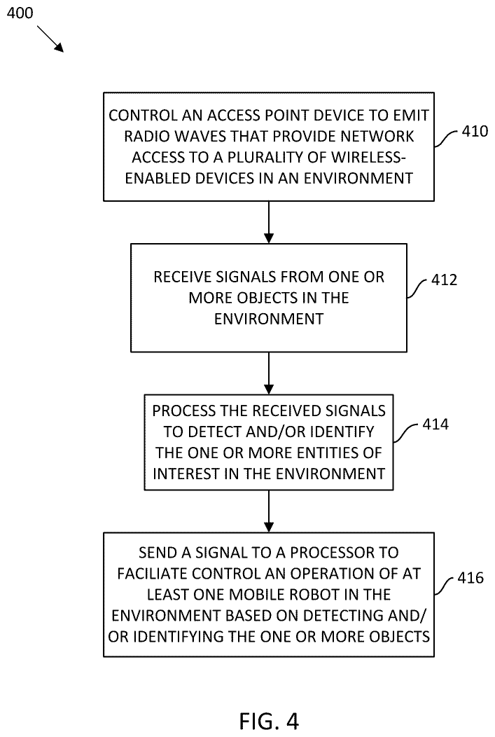

FIG. 4 illustrates a process 400 for using an access point device to detect and/or identify one or more objects in an environment, in accordance with some embodiments. Process 400 may begin in act 410 where an access point device may be controlled to emit radio waves that provide network access (e.g., via a wireless local area network) to a plurality of wireless-enable devices in an environment. In some embodiments, the emitted radio waves may provide a WiFi local area network within the environment, such as a warehouse. Process 400 may then proceed to act 412, where signals may be received by the access point device from one or more objects in the environment. For example, the access point device may include one or more signaling components (e.g., signaling components 316 shown in the example of FIG. 3), and signals may be received via the one or more signaling components. Process 400 may then proceed to act 414, where the received signals are processed to detect and/or identify one or more objects in the environment. In some embodiments, at least a portion of the processing may be performed in one or more access point devices. In other embodiments, the signals and/or information derived from the signals may be transmitted to a computer processor (e.g., included in processor 330 shown in the example of FIG. 3) for detection and/or identification of the one or more objects in the environment. Process 400 may then proceed to act 416, where a signal is sent from the access point device to a processor (e.g., processor 330 shown in the example of FIG. 3) to facilitate control of an operation of a least one mobile robot in the environment, wherein the control is based on the detecting and/or identifying of the one or more objects in the environment. For example, as described herein, processor 330 may be configured to store and dynamically update a model/map of an environment including objects located therein. The processor may be configured to respond to queries from mobile agents operating in the environment with information that may be used to control the operation of the mobile agents.

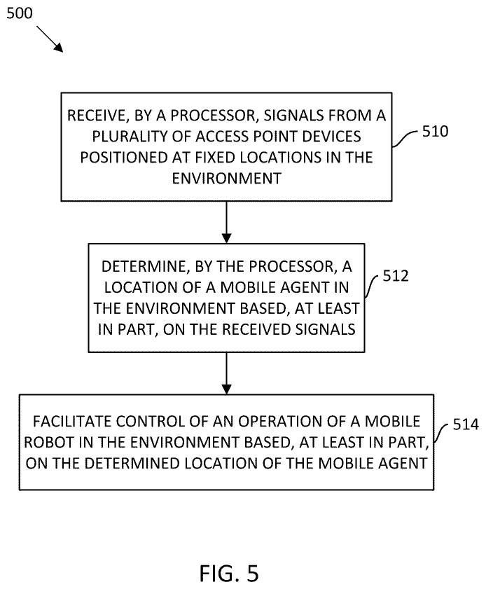

FIG. 5 illustrates a process 500 for facilitating control of an operation of a mobile robot based on a location of a mobile object in an environment, in accordance with some embodiments. Process 500 may begin in act 510, where signals (e.g., signals or signals derived from sensors signals) are received by a processor (e.g., processor 330 shown in the example of FIG. 3) from a plurality of access point devices positioned at fixed locations in the environment. For instance, as described above, a plurality of access point devices configured to provide a wireless local area network in an environment such as a warehouse may also include signaling components that enable the access point devices to sense objects in the environment. Process 500 may then proceed to act 512, where a location of a mobile agent in the environment is determined based, at least in part, on the received signals. In some embodiments, the processor is configured to store information on a physical location of each of the plurality of access point devices in the environment, and the location of the access point devices may be used, at least in part, to determine the location of the mobile agent in the environment. In some embodiments, a model/map may be maintained and dynamically updated (e.g., by a central processor, such as processor 330 in FIG. 3), and the location of the mobile agent and other objects in the environment may be reflected in the model/map. Process 500 may then proceed to act 514, where the processor facilitates control of an operation of a mobile robot in the environment based, at least in part, on the determined location of the mobile agent. For example, if the detected mobile agent is a human, the processor may be configured to send a signal to a mobile robot within a threshold proximity of the detected mobile agent to slow its operation, activate one or more alarms onboard the robot, and/or come to an operational stop until the human is located more than the threshold distance from the mobile robot, thereby facilitating safe operation of the mobile robot.

In some embodiments, a processor (e.g., processor 330 shown in the example of FIG. 3) may be configured to facilitate control of a mobile robotic device in an environment (e.g., environment 300) by instructing the mobile robotic device to navigate to a particular location in the environment. After arriving at the particular location, the mobile robotic device may be controlled to perform an action associated with a local area network provided in the environment. For example, as described in more detail below, in some embodiments mobile robotic devices may be controlled to perform automatic commissioning of access point devices, boosting of a local area network signal, or failover to a secondary network when network connectivity for a primary local area network (e.g., provided by a plurality of access point devices) is lost.

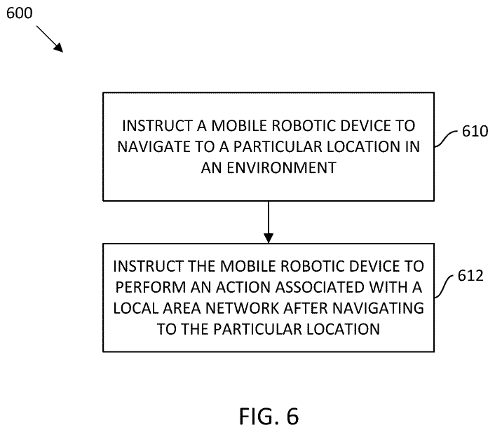

FIG. 6 illustrates a process 600 for performing actions associated with a local area network, in accordance with some embodiments. Process 600 may begin in act 610, where a mobile robotic device (also referred to herein simply as a “mobile robot”) is instructed to navigate to a particular location in an environment. In some embodiments, the particular location may be determined (e.g., by processor 330 in environment 300) based, at least in part, on an action that is to be performed. For instance, in the case of automated commissioning, the mobile robotic device may be instructed to navigate to a particular location near a particular access point device to determine the physical location of the access point device in the environment. In the case of boosting a local area network signal, the mobile robotic device may be instructed to navigate to particular location where the local area network signal is weak (e.g., as reported by one or more mobile robots operating at that location). It should be appreciated that a mobile robotic device may be instructed to navigate to a particular location based on any of a variety of factors including, but not limited to, the location and/or capabilities of other mobile robotic devices in the environment, and local area network characteristics in the environment.

Process 600 may then proceed to act 612, where the mobile robotic device may be instructed to perform an action associated with a local area network after navigating to the particular location. In some embodiments, the mobile robotic device may be instructed to perform an action (e.g., acting as a node in the local area network) by virtue of navigating to the particular location. For example, when the mobile robotic device is configured as a node in the local area network, the mobile robotic device may be “instructed” to boost the local area network signal when it arrives at the particular location without receiving a separate instruction to perform the action. In other embodiments, the mobile robotic device may receive a separate instruction to perform an action (e.g., perform automated commissioning) or the instruction to perform an action may be combined with the instruction to navigate to the particular location. Non-limiting example of actions to be performed by mobile robotic devices instructed to navigate to particular locations in the environment are described herein.

In some embodiments, performing an action includes maintaining network communication for a mobile agent (e.g., a mobile robot) operating at or near the particular location. For instance, the mobile agent may be instructed to navigate in the environment based on the particular location of the mobile robotic device instructed to perform the action. For instance, the mobile robotic device may be instructed to navigate to a particular aisle in a warehouse and perform an action by boosting the local area network signal in that aisle as a result of navigation to the aisle. A mobile robot traveling through the warehouse may be instructed to travel through the aisle with the boosted signal to facilitate maintaining network communication while traveling through the warehouse.

As described herein, a localization system implemented using the architecture described herein (e.g., using a processor and a plurality of access point devices equipped with sensing capabilities) may perform localization of objects in an environment based, at least in part, on the location of the plurality of access point devices and the signals sensed by their respective signaling components 316. The locations of access point devices installed at various places in an environment, such as a ceiling of a warehouse, are conventionally determined using rough approximation techniques (e.g., a ladder and a tape measure). However, knowing a precise location of access point devices in an environment may be important when that information is used for localization of objects in the environment, and may be even more important when implementing a safety-rated localization system. The inventors have recognized and appreciated that conventional techniques for determining the location of access point devices in environment (e.g., environment 300) may be improved using one or more controllable mobile agents (e.g., one or more mobile robots) in the environment.

In some embodiments, one or more mobile robots may perform automated commissioning of access point devices in an environment. Such automated commissioning may enable the determination of actual trustable locations of the access point devices for use in a localization system. For instance, a processor (e.g., processor 330) may send an instruction to a controllable mobile agent (e.g., a mobile robot) to navigate to a particular location in an environment (e.g., environment 300) near a location of an access point device for which its location is to be determined. After navigating to the particular location, the mobile agent may determine the location of the access point device using one or more onboard sensors and provide information about the location of the access point device to the processor, which may be configured to store information about each of the plurality of access point devices in the environment (e.g., for use in a localization system).

In some embodiments, the processor may be configured to control the mobile robot(s) to determine the location of each of plurality of access point devices when the devices are first installed (e.g., prior to use). For instance, when the access point devices are first installed, a measurement about where the access point devices are located in space may be determined (e.g., using conventional techniques). Then, the actual positions of the access point devices may be refined and/or verified based on measurements from sensor(s) onboard the robot(s) as described herein. In some embodiments, the processor may be configured to control the mobile robot(s) to determine the location of a particular access point device in response to detecting that the location of the access point device is likely incorrect. For instance, it may be determined that a location of an access point device is incorrect when a localization system implemented by the processor determines that a human and a mobile robot are located at exactly at the same location in the environment. In some embodiments, one or more mobile robots may be configured to periodically or continuously determine the position of access point devices in the environment as the robot(s) traverse the environment (e.g., without receiving explicit instructions to navigate to a location near a particular access point device).

In some embodiments, environment information sensed by one or more mobile robots may be used to determine possible locations for placing access point devices in an environment. In such a way, the sensed information from the mobile robot(s) may be used to map the environment to ensure that once installed, the access point devices may provide adequate local area network coverage for the mobile devices and/or mobile agents operating in the environment. One or more mobile robots in an environment may include an odometry system configured to estimate the pose of the robot using sensors (e.g., internal measurement units (IMUs), accelerometers, gyroscopes, GPS, LIDAR sensors, cameras, etc.) onboard the robot. In some embodiments, the location of an access point device may be determined by a mobile robot based, at least in part, on the robot's odometry system.

In some embodiments, one or more controllable mobile agents may be used to perform other actions associated with a local area network. For instance, one or more mobile devices in an environment (e.g., environment 300) may rely on the local area network for communication (e.g., with processor 330) to enable the mobile devices to operate properly and/or safely. As an example, a mobile robot operating in a warehouse environment may need to establish communication with a processor to perform a particular job (e.g., unloading boxes from a pallet) and to be able to receive safety information (e.g., from an eye-in-the-sky localization system) that it may need to augment the safety sensors onboard the robot.

When the first mobile robot is unable to communicate with the processor (e.g., due to a wireless local area network dead spot in the network or some other network communication failure), the first mobile robot may be required to power down or operate at a minimum speed until the processor indicates to the first mobile robot that it can operate at a faster speed. In such an instance, the processor (e.g., processor 330) may instruct a second mobile robot to navigate to a location near the first mobile robot that is unable to communicate with the processor. After navigating to the location near the first mobile robot, the second mobile robot may be configured to operate as an access point device to boost the local area network signal in the vicinity of the first mobile robot, thereby enabling the first mobile robot to communicate with the processor. Accordingly, in some embodiments mobile robots operating in an environment may be dynamically configured as nodes in a wireless local area network to provide communication capabilities to mobile devices and/or mobile agents within the environment.

In some embodiments, one or more controllable mobile agents may be used to provide a failover operation to a secondary network when a primary local area network provided by the plurality of access point devices in an environment is lost. For instance, as described above, each of the plurality of access point devices may include a network interface that provides mobile devices and/or mobile agents in an environment access to a wired network (e.g., Ethernet network) coupled to the access point device. Collectively, the plurality of access point devices may provide a primary local area network that can be used for communication within the environment. When there is a disruption to the wired network connection (e.g., at an Internet service provider, the network line entering a building being severed, etc.) the entire primary local area network may be disrupted, which may result in all of the mobile devices and/or mobile agents operating in the environment to cease operation.

In some embodiments, one or more of the mobile agents in the environment may include multiple network interfaces (e.g., a first network interface 322 configured to communicate with the access point devices using WiFi communication and a second network interface 324 configured to communicate via a cellular (e.g., LTE) communication standard). In the event that the primary local area network provided by the plurality of access point devices is disrupted, a plurality of mobile robots may be controlled to provide a secondary network (e.g., a wireless mesh network based on LTE modems onboard the plurality of mobile robots) that enable the mobile devices and/or mobile agents in the environment to continue operating using the secondary network even when the primary local area network is down. In some embodiments, the plurality of mobile robots may be configured as nodes in the secondary network and may be positioned in the environment at locations that provide wireless mesh network coverage to wireless devices operating in the environment. As mobile robots and other wireless devices continue to move in the environment, the mobile robots used as secondary network nodes may move correspondingly to ensure that there is sufficient network coverage in the environment to reduce and/or prevent disruption of robot operation due to a primary local area network failure.

As described herein, it is important that mobile robots configured to operate in environments that may include humans do so safely by, for example, avoiding collisions with humans or other potential obstacles when moving within the environment. Sensors onboard the mobile robot may be configured to sense for nearby entities of interest and the robot's behavior may be adjusted when an object (e.g., a human) is sensed within a monitored safety region near the robot. Due to obstructed views, robot-mounted sensors may sometimes not be able to sense entities of interest within an entire safety region surrounding a mobile robot to ensure that the region is free of potential collisions. When safe operation of the robot cannot be ensured, the operation of the robot may be limited or stopped in ways that reduce the productivity of the robot. In some embodiments, sensors mounted in places other than on the robot, examples of which are described herein, may be used to augment the on-board sensors of a mobile robot to allow the robot to operate safely while maintaining a high level of productivity.

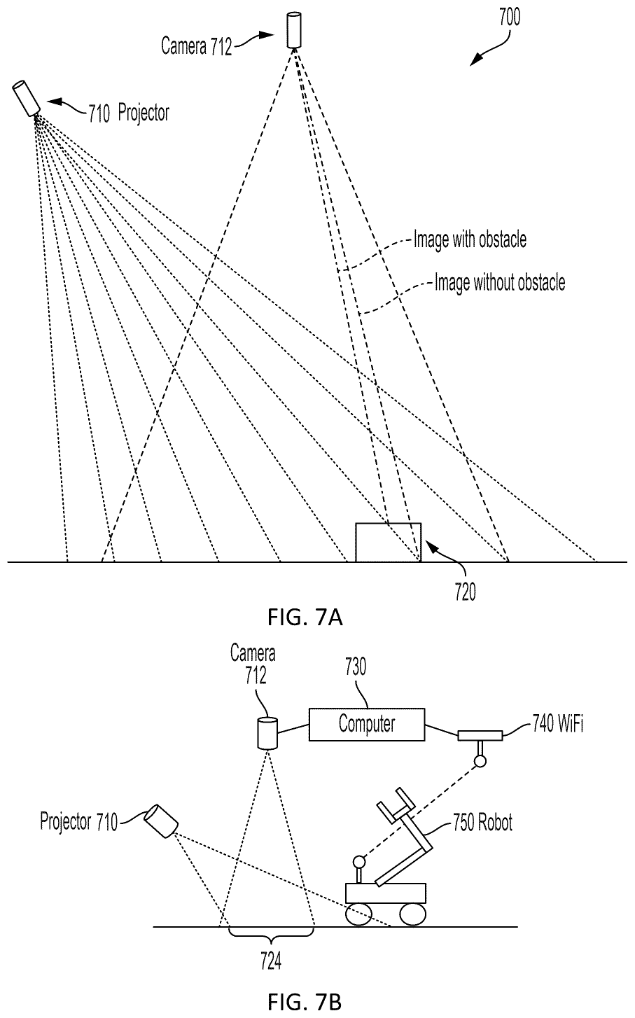

FIG. 7A illustrates an example system 700 in which one or more sensors in an environment of a robot (also referred to herein as “off-robot” sensors) are used to monitor a region of interest, in accordance with some embodiments. As shown in FIG. 7A, a projector 710 may be configured to project one or more light patterns onto a surface (e.g., a ground surface) within a monitored region of interest. In some embodiments, projector 710 (e.g., implemented as a laser projector) may be configured to project a single (e.g., stationary) light pattern or a sequence of light patterns. Any suitable light pattern(s) may be used including, but not limited to, visible light patterns, infrared light patterns, or near infrared light patterns. In some embodiments, the projected light pattern may be a grid with lines spaced slightly less than the horizontal dimension of the smallest object to be detected in the monitored region. Accordingly, when an object is present in the monitored region, a change in the projection light pattern may be detected. In some embodiments, projector 710 may be mounted to infrastructure in a fixed position in an environment (e.g., a warehouse or other industrial environment). For example, projector 710 may be included as a signaling component within a network access point device (e.g., signaling component 316 in network access point device 310a shown in FIG. 3) as described herein.

A camera 712 may be configured to capture one or more images of at least a portion of the monitored region on which the one or more light patterns are projected by projector 710. In some embodiments, camera 712 may be mounted to infrastructure in a fixed position in an environment (e.g., a warehouse or other industrial environment). For example, camera 712 may be included as a signaling component within a network access point device (e.g., signaling component 316 in network access point device 310a shown in FIG. 3) as described herein. In some embodiments, the one or more images captured by the camera may be analyzed to determine whether the monitored region is clear of entities of interest (also sometimes referred to herein as “obstacles” (e.g., humans or other objects with which the robot may collide during operation)). For example, if the image(s) captured by camera 712 show a clear (e.g., unchanged) view of the projected light pattern(s) over the entire region of interest, the region may be identified as being clear of obstacles, and the robot may be enabled to operate safely without restriction. By contrast, if a change in the projected light pattern(s) is observed in the captured image(s), it may be determined that a possible obstacle may exist in the monitored region, and an operation of the robot may be adjusted accordingly (e.g., the operation of the robot may be slowed, stopped, or limited in some other way).

FIG. 7B schematically illustrates a system for obstacle detection within a region of interest, in accordance with some embodiments. As shown, the system includes projector 710 and camera 712, as previously described in connection with FIG. 7A. Projector 710 may be configured to project one or more light patterns on a surface near a robot 750. Camera 712 may be configured to capture one or more images of a monitored region of interest 724 on the surface upon which the light pattern(s) are projected. Camera 712 may be communicatively coupled to computer 730 configured to process the one or more images captured by camera 712. For example, computer 730 may include one or more computer processors configured to analyze captured images to detect obstacles in region of interest 724 by detecting changes in the light patterns projected by projector 710. In response to processing the images, computer 730 may be configured to provide information vis network device 740 to robots (e.g., robot 750) in a given region (e.g., robots in the vicinity of the monitored region) about the presence or absence of entities of interest within the monitored region (e.g., region of interest 724). In some embodiments, network device 740 may be configured to communicate with mobile robots in the environment using a wireless networking protocol (e.g., WiFi). In some embodiments, network device 740 may be a network access point device as described herein. In some embodiments, the system may be designed to minimize the delay between image capture by camera 712 and providing information about an obstructed/unobstructed region to robot 750 in the vicinity of the monitored region.

FIG. 7A schematically illustrates how the presence of an object 720 in a monitored region of interest may be detected, in accordance with some embodiments of the present disclosure. In some embodiments, the position of projector 710 may be arranged to project light pattern(s) at an angle relative to the angle in which camera 712 is configured to capture images of the projected light pattern(s). With such an arrangement, a sufficiently large object in the monitored region of interest may either obstruct the projection of the light pattern(s) to the surface or change the visual location of portions of the projected light pattern(s) in the captured image(s). For example, as illustrated in FIG. 7A, when object 720 is present in the region of interest on which a light pattern is projected by projector 710, an image captured by camera 712 will show a disturbance (e.g., a change in the spacing between the projected lines) in the light pattern projected by the projector 710, whereas if the object 720 is not present in the region of interest, the projected light pattern may remain unchanged. When it can be determined from the image(s) captured by camera 712 that the image is sufficiently unchanged, it can be confirmed with high reliability that the monitored region of interest is unoccupied by obstacles.

In some embodiments, a sequence of light patterns may be projected onto a surface in a monitored region of interest, and the timing of the projection of the sequence of light patterns may be synchronized with the process of checking for changes in the captured images. By time synchronizing the projection and the change detection processes, an additional check that the system is operating properly may be provided, further increasing the reliability of the system. Additionally, such time synchronization may also be used to increase the effective resolution of obstacle detection within the monitored region.

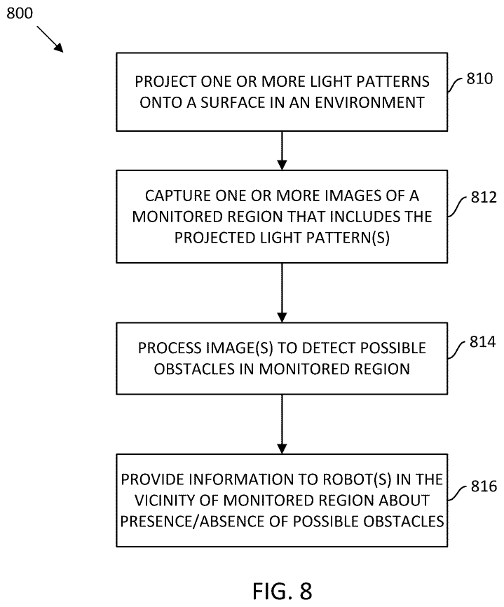

FIG. 8 illustrates a process 800 for using off-robot sensors to monitor regions near a robot, in accordance with some embodiments of the present disclosure. Process 800 begins in act 810, where one or more light patterns are projected into a surface (e.g., a ground surface) in an environment in which one or more mobile robots are operating. Process 800 then proceeds to act 812, where one or more images of a monitored region that includes the projected light pattern(s) are captured by a camera. Process 800 then proceeds to act 814, where the image(s) captured by the camera are processed to detect possible obstacles in the monitored region. For example, each image captured by the camera may include a timestamp and images captured over time may be compared to determine whether changes in the projected light pattern(s) have occurred. When a change in the projected light pattern(s) is detected, it may be determined that a possible obstacle is present in the monitored region. Process 800 then proceeds to act 816, where information is provided to one or more robots in the vicinity of the monitored region, where the information indicates the presence or absence of possible obstacles in the monitored region. In some embodiments, when it is determined that a given image shows a region free of obstacles, information may be sent to some or all robots in a vicinity of the monitored region with a region identifier and an image timestamp. Robots receiving the information about the presence or absence of obstacles in the monitored region may use the information in movement planning, performing navigation, and/or manipulation of objects.

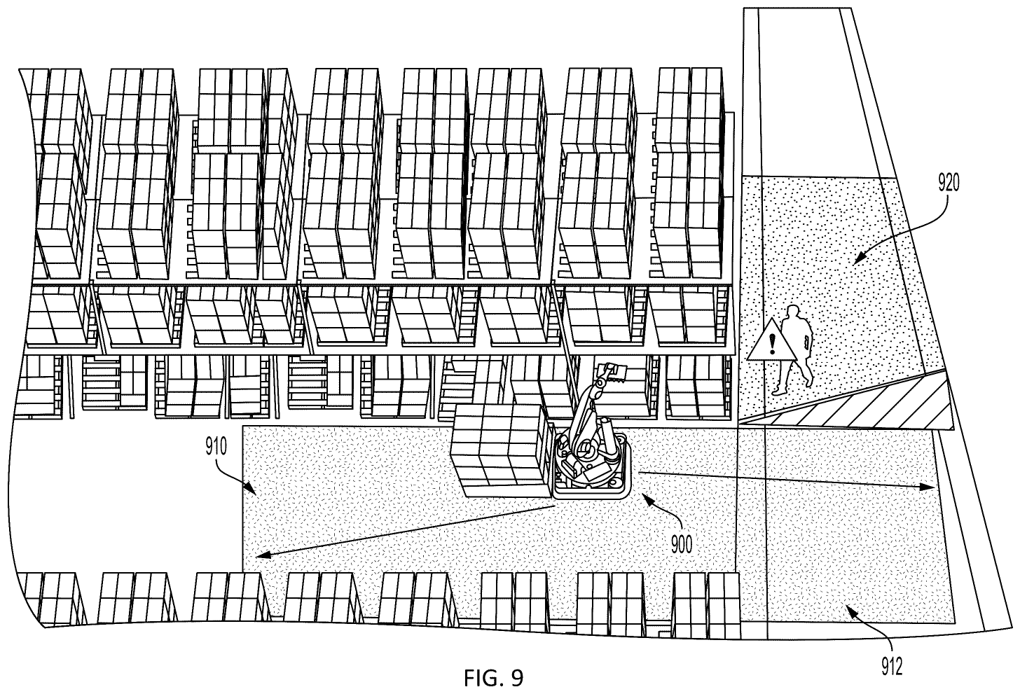

As described herein, a mobile robot may operate in an environment such as a warehouse or other industrial setting that may include humans, vehicles, and other robots. To increase productivity, it may be desirable to have the robot operate as fast as possible given the task that it is instructed to perform. However, infrastructure within the environment that the robot is operating may not always allow onboard sensors of the robot to have a line of sight sufficient for the robot to operate safely at efficient speed. FIG. 9 illustrates one such example in which sensors onboard a mobile robot may be insufficient to enable the robot to operate at efficient speeds due to safety concerns. As shown in FIG. 9, a mobile robot 900 operating at the end of an aisle in a warehouse may be tasked with grasping boxes from a warehouse shelf and placing the boxes on a cart coupled to the robot 900. Sensors onboard the robot may be capable of identifying obstructions within regions of the aisle (e.g., regions 910, 912), but may be incapable of sensing the present of obstructions (e.g., humans, vehicles, other robots, etc.) in a blind spot region 920 due to occlusions by the shelving along the aisle. Due to the uncertainty regarding whether obstructions may be present within blind spot region 920, mobile robot 900 may be configured to operate slowly and therefore less efficiently when it is operating at locations in which there is partial occlusion of a safety zone surrounding the robot as sensed by its onboard sensors. It should be appreciated that the scenario depicted in FIG. 9 is merely one example of a situation in which the onboard sensors of a mobile robot may have a limited view its surrounding region. For example, a legged robot (e.g., a bipedal or quadruped robot) having onboard sensing capabilities may have sensing blind spots when traversing stairs. The presence of such blind spots and their impact on a mobile robot's safe operation may be at least partially mitigated using one or more of the techniques described herein.

Warehouses and other industrial environments often contain devices and procedures that are intended to prevent collisions at blind corners. For example, such environments may include mirrors, sensors with flashing lights, crosswalks/stop signs, floor projections by approaching vehicles, RFID tag warning systems, and/or may implement procedures such as stopping at the end of an aisle and beeping a horn. Some conventional solutions for tracking entities of interest using anchors, tags and wireless communication may not have sufficient reliability for a safety system for a mobile robot. Some conventional solutions for using building mounted sensors to sense people in warehouse and industrial environments, such LIDAR and light curtains may be cost prohibitive at scale in a warehouse that includes hundreds or thousands of ends of aisles and other potential blind spots, and/or may not have sufficient reliability for safety decision making. The inventors have recognized and appreciated that the information provided by onboard sensors for ensuring safe operation of a mobile robot may be augmented by one or more off-robot sensors in the environment in which the robot is operating. Additionally, in some embodiments, a system of deployed off-robot sensors (or a central system with data from the off-robot sensors) may be used to signal to humans and/or communicate to mobile robots in an environment one or more “traffic signals,” that enable efficient operation of mobile robots when it is safe to do so, and which may be used to direct traffic when more than one mobile agent is present in an area of the environment. As described in further detail below, some embodiments are directed to using off-robot sensors to sense potential obstructions in blind spot regions of an onboard robot sensor system (also referred to herein as a “self-safeguarding” system), which may enable a mobile robot to operate efficiently without sacrificing safety of humans, other robots or vehicles operating within the same environment.

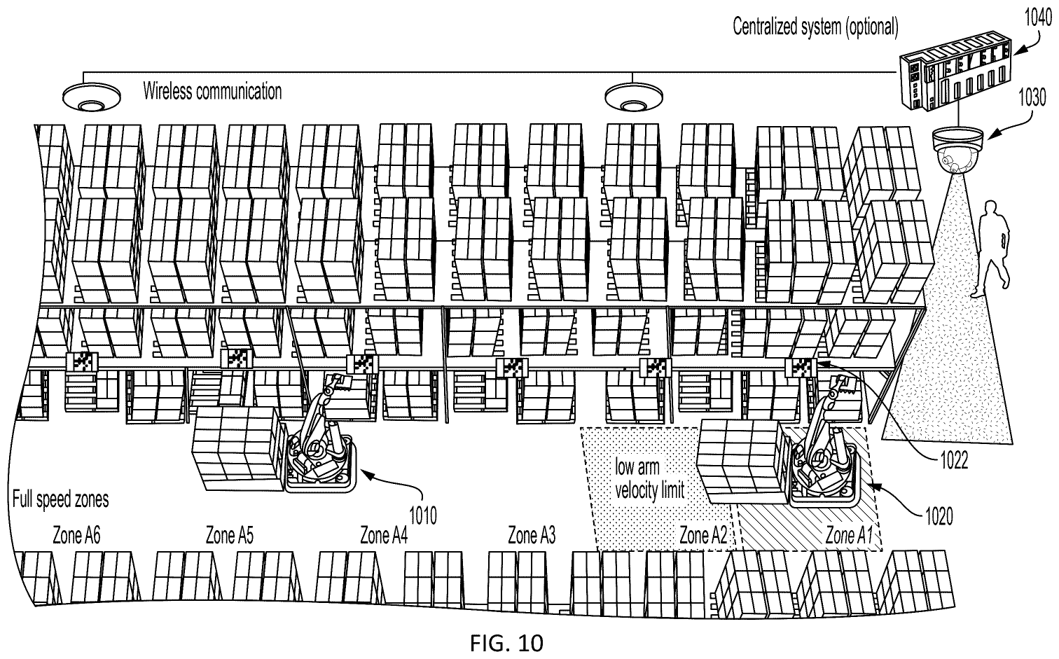

FIG. 10 illustrates a scenario for augmenting an onboard sensor system of a mobile robot using one or more off robot sensors, in accordance with some embodiments of the present disclosure. As shown in FIG. 10, a warehouse environment may have multiple mobile robots operating therein. A first mobile robot 1010 may be configured to pick-and-place objects (e.g., boxes) from an attached cart onto a shelf in an aisle of the warehouse and/or load objects from the shelf onto the attached cart. The first mobile robot 1010 may be operating at a location in the aisle in which its onboard sensors can reliably detect obstructions within the aisle that may cause the robot to limit its behavior. Accordingly, first mobile robot 1010 may safely operate at a desired speed (e.g., full speed) to improve the efficiency of the pick and place operations. A second mobile robot 1020 may be performing the same pick and place operation, but at a different location in the aisle (e.g., the end of an aisle) at which the robot's onboard sensors cannot reliably detect obstructions near the robot. For example, as described in the scenario shown in FIG. 9, when a mobile robot is operating at the end of an aisle, its onboard sensors may not be able to sense entities of interest around corners of the shelving of the aisle, resulting in blind spot regions that the self-safeguarding system of the robot cannot sense. As shown in FIG. 10, some embodiments utilize sensor information from off-robot sensors configured to complement the self-safeguarding system of a mobile robot to reliably observe obstructions in the blind spot region(s) of the robot's onboard sensing system. In the example shown in FIG. 10, the safety monitoring system includes a sensor 1030 mounted to infrastructure (e.g., the ceiling) of the warehouse. Sensor 1030 may be configured to sense entities of interest in the blind spot region of the mobile robot 1020 (e.g., around the corner of an aisle when operating at the end of an aisle). Sensor 1030 may be communicatively coupled to a central processing system 1040. Central processing system 1040 may be configured to wireless communicate with one or more wireless devices (e.g., mobile robots 1010, 1020) in the environment. In some embodiments, sensor 1030 may be included as a signaling component within a network access point device (e.g., signaling component 316 in network access point device 310a shown in FIG. 3) as described herein.

As shown in FIG. 10, in some embodiments, a warehouse or other industrial environment may be segmented into different zones within which mobile robots may operate differently. For instance, in some zones mobile robots may be able to operate at any desired speed (e.g., maximum speed) for a particular task they are performing, whereas in other zones, operation (e.g., speed, range of motion, etc.) of the robot may be limited in some way. Robots operating within the environment may determine their location in the environment (e.g., which zone they are operating in) in any suitable way. In the example shown in FIG. 10, an aisle of a warehouse includes tags 1022 capable of being read by a mobile robot operating in the vicinity of the tag. In some embodiments, a mobile robot may determine its location based on the tag 1022. For example, tag 1022 may be a 2-factor tag that mobile robot 1020 may sense using an onboard sensor (e.g., a camera, an RFID scanner, etc.). After sensing the tag 1022, the mobile robot 1020 may request (e.g., from a central system) or determine (e.g., based on onboard computing resources) safe operating parameters for the particular location/zone. For instance, when operating in zone A1 as shown in FIG. 10, robot 1020 may determine that its self-safeguarding system should be augmented with sensor data sensed by sensor 1030 due to the blind spot region around the corner of the aisle. Although FIG. 10 shows the warehouse environment as having different discrete zones associated with different safe operating parameters, it should be appreciated that dividing an environment into discrete zones is not necessarily required and other techniques for localizing a robot in an environment and associating the robot's location with safe operating parameters at its current location may alternatively be used.

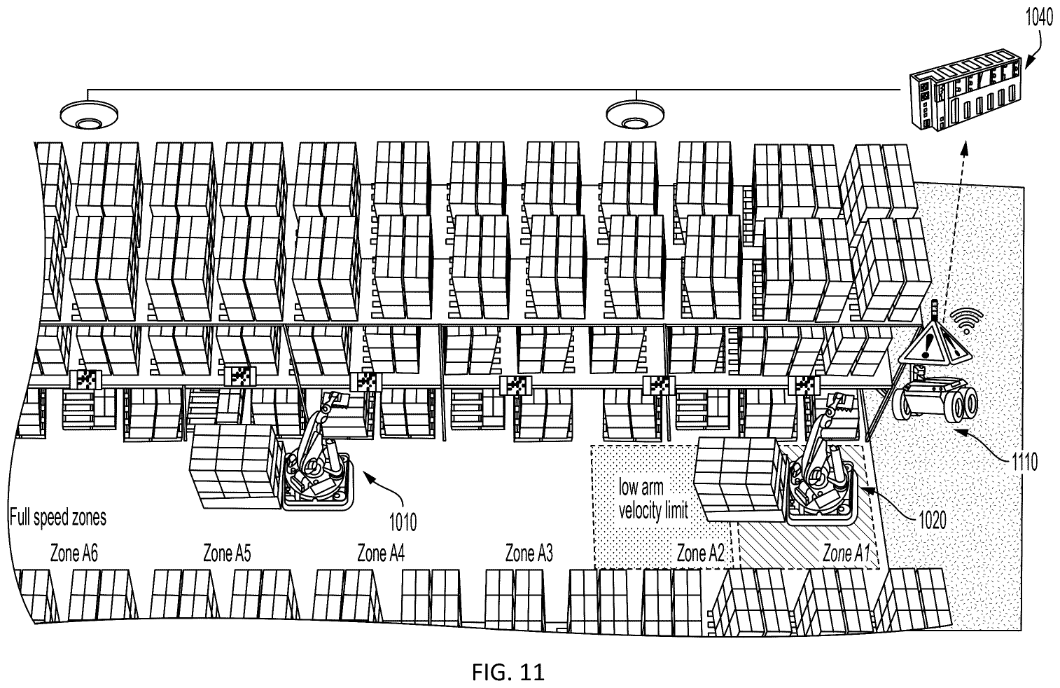

In the example of FIG. 10, an off-robot sensor 1030 fixed to infrastructure in the environment is used to sense entities of interest in a blind spot region of a mobile robot's self-safeguarding system. FIG. 11 shows another example scenario in which the off-robot sensor used to sense entities of interest in a blind spot region is coupled to a mobile agent 1110 such as another mobile robot. In such a scenario, the mobile agent 1110 may serve as a “lookout” agent for a mobile robot (e.g., mobile robot 1020). Mobile agent 1110 may be tasked with detecting obstructions in the blind spot region only when needed, which may allow one lookout mobile agent 1110 to cover multiple blind spots for different mobile robots operating in different areas of the environment. As shown in FIG. 11, mobile agent 1110 may be communicatively coupled (e.g., wireless coupled) to a central processing system 1040, which may be configured to wirelessly communicate with one or more wireless devices (e.g., mobile robots 1010, 1020) in the environment as described in connection with the scenario shown in FIG. 10.

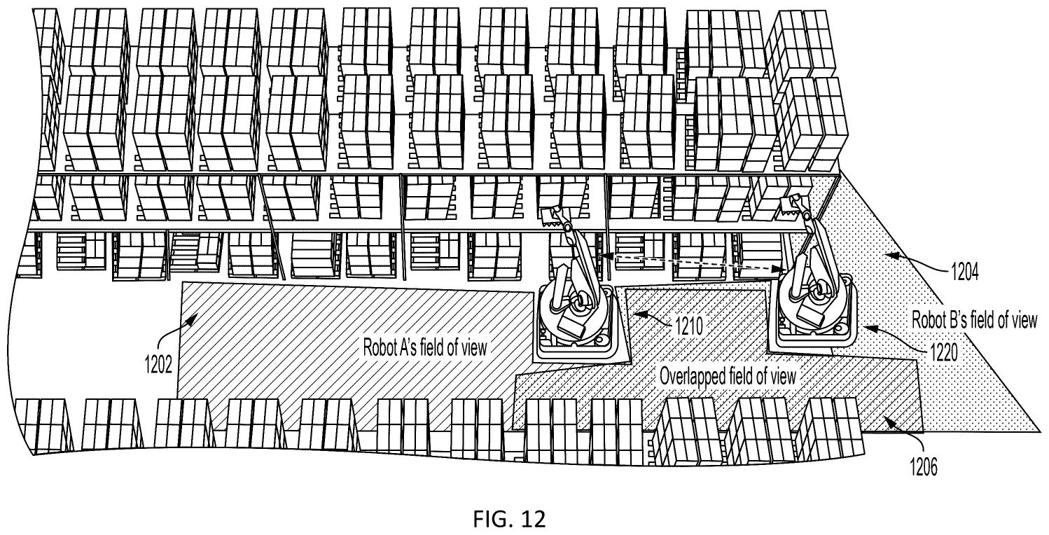

FIG. 12 illustrates a scenario in which a first mobile robot 1210 and a second mobile robot 1220 are operating within a same area of a warehouse environment. In the example shown in in FIG. 12, each of the mobile robots at least partially occludes the field of view of the other mobile robot's onboard sensor system. For example, the first mobile robot 1210 can sense obstructions in region 1202 and region 1026, but cannot observe obstructions in region 1204, whereas the second mobile robot 1220 can sense obstructions in region 1204 and 1206, but cannot observe obstructions in region 1202. In some embodiments, the first mobile robot 1210 and the second mobile robot 1220 may communicate with each other (e.g., using wireless communication) to share sensor information such that each robot can continue operating at efficient speeds despite its own self-safeguarding system being partially occluded by the other robot. For example, if the mobile robots can recognize each other, understand each other's pose, and can reliably communicate the data of their onboard safety sensor systems, both robots can confidently operate at efficient speeds even when their individual self-safeguarding systems have occlusions.

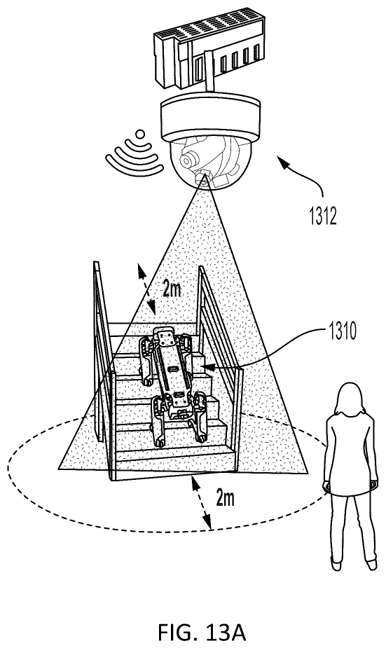

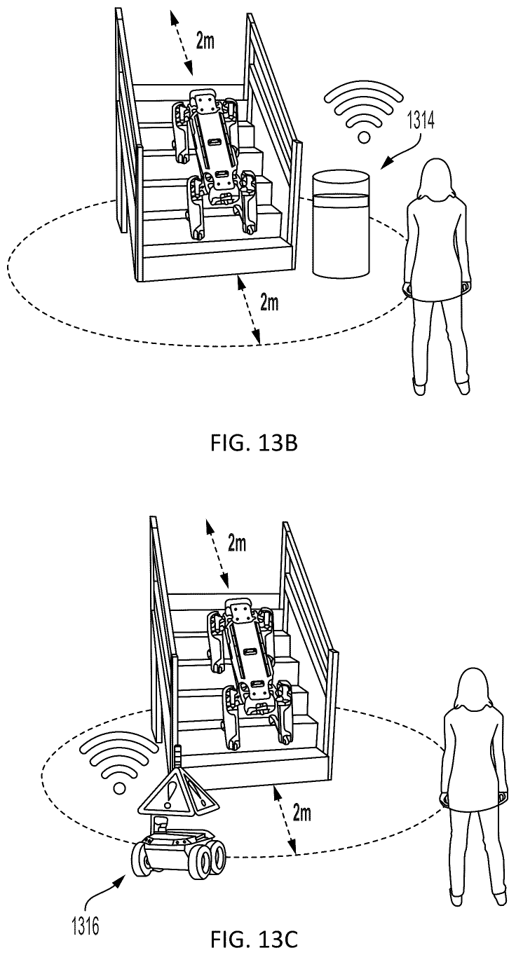

FIGS. 13A-13C illustrate example scenarios in which one or more off-robot sensors can be used to supplement an onboard safety system of a mobile robot, in accordance with some embodiments. The scenarios illustrated in FIGS. 13A-13C relate to the traversal of a legged mobile robot (e.g., a quadruped robot) along a set of stairs. In the scenario shown, the onboard safety sensors of the mobile robot may be unable to make decisions about safe actions with respect to the presence of entities of interest located downhill on stairs (e.g., at the foot of the stairs). FIG. 13A shows a mobile robot 1310 travelling down a set of stairs. Although the robot's self-safeguarding system may be capable of sensing the presence of entities of interest up and down the stairs themselves, the mobile robot 1310 may not be capable of sensing the presence of entities of interest within a particular radius (e.g., within a 2 meter radius) at the foot of the stairs to determine whether it is safe of the robot 1310 to continue off of the stairs and onto the ground surface. In some embodiments, a deployed off-robot sensor may be used to monitor this blind spot location and report relevant safety data about the presence of entities of interest in the monitored area. FIG. 13A schematically illustrates a first embodiment in which a sensor 1312 fixed to the infrastructure of the environment (e.g., included as a sensing component in a network access point device as described herein) is used to monitor the region at the foot of the stairs. FIG. 13B schematically illustrates a second embodiment in which a temporary static sensor 1314 (e.g., a sensor that is not permanently fixed to infrastructure of the environment) is used to monitor the region at the foot of the stairs. FIG. 13C schematically illustrates a third embodiment in which a sensor located on a mobile agent 1316 (e.g., another mobile robot) is used to monitor the region at the foot of the stairs. As described in connection with the scenario shown in FIG. 10, a mobile agent (e.g., mobile agent 1316) may be tasked with detecting obstructions in the blind spot region of a mobile robot only when needed, which may allow one mobile agent 1316 to cover multiple blind spots for different mobile robots operating in different areas of the environment.

Irrespective of the type of off-robot sensor used to monitor a blind spot region of a mobile robot, coordination between the robot's onboard self-safeguarding system and the one or more external off-robot sensors may be needed to inform the robot that it is free to operate (e.g., move, manipulate objects), when the off-robot sensor(s) verify that a human/obstacle is not present in the robot's blind spot region and/or to inform the robot that operation should be limited when a human/obstacle is present in the monitored region. In some embodiments, the mobile robot's onboard safety system may limit operation of the mobile robot when one or more blind spots near the robot are detected. When a signal is received from an off-robot sensor system that the blind spot is clear of entities of interest, the limit on the operation of the mobile robot may be altered to allow the mobile robot to operate normally or with reduced limitations. The signal from the off-robot sensor system may be provided in different ways depending, for example, on what type of off-robot sensors are used to monitor the blind spot region. For instance, as shown in FIG. 13A, a fixed infrastructure sensor may be communicatively coupled to a central processing system (e.g., central processing system 1040 in FIG. 10), and the central processing system may provide the signal wirelessly to the mobile robot. In some embodiments, such as those shown in FIGS. 13B and 13C, the off-robot sensor(s) may provide information to a central processing system, which may provide the signal to the mobile robot and/or the off-robot sensor(s) may provide the signal directly to the mobile robot without use of a central processing system.

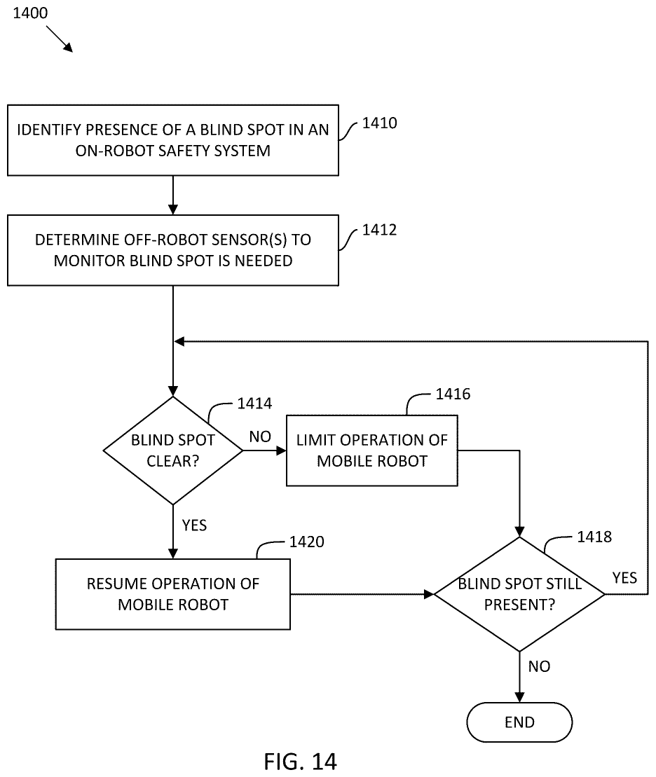

FIG. 14 illustrates a process 1400 for using one or more off-robot sensors to monitor a blind spot of an on-robot safety system, in accordance with some embodiments. Process 1400 may begin in act 1410, where the presence of a blind spot in an on-robot safety system is identified. The presence of a blind spot may be determined in any suitable way. For example, in some embodiments, sensor data from the on-board system may be analyzed to identify the presence of a blind spot. In some embodiments, one or more locations in the environment (e.g., the end of aisles) may include a physical identifier (e.g., a visual tag) that the mobile robot can recognize to identify the presence of a blind spot at that location. In some embodiments, the presence of one or more off-robot sensors at a particular location may be used to identify the mobile robot is at a location where a blind spot may be present. When it is determined that a blind spot is present, process 1400 may proceed to act 1412 where it is determined that off-robot sensor(s) to monitor the blind spot is needed. For instance, a mobile robot may request assistance from one or more off-robot sensors in the vicinity of the mobile robot to monitor the blind spot region for entities of interest. The request for assistance may be initiated from the mobile robot associated with the blind spot, a centralized processing system, another mobile agent, or the request for assistance may be initiated in any other suitable way. In some embodiments, a request for assistance may not be needed. For instance, if off-robot sensors are configured to continuously detect objects in an environment, a mobile robot may be provided access to the information being sensed by the off-robot sensors when needed to monitor a blind spot associated with the mobile robot.

Process 1400 may then proceed to act 1414 where it is determined based, at least in part, on the off-robot sensor data whether the blind spot region of the onboard safety system of the robot is clear of entities of interest. For example, as described herein, the off-robot sensor system may be configured to capture and analyze images that cover the blind spot region to identify the presence/absence of entities of interest in the blind spot region. If it is determined in act 1414 that the blind spot is not clear (e.g., a human is present in the blind spot region), process 1400 may proceed to act 1416, where one or more operations of the robot are limited. For example, the robot may be instructed and/or controlled to operate slower, shut down, etc. Process 1400 may then proceed to act 1416, where it may be determined whether the blind spot in the on-robot safety system still exists. If it is determined that the blind spot still exists, process 1400 may return to act 1414 where the off-robot sensor data is again used to determine whether the blind spot is clear of entities of interest. If it is determined in act 1414 that the blind spot is clear of entities of interest, process 1400 may proceed to act 1420, where one or more limitations on the operation of the mobile robot may be removed. For instance, if the movement of the mobile robot was previously limited due to the presence of an entity of interest in the blind spot region, the limitation may be removed such that faster and/or less constrained operation of the mobile robot may be resumed. Process 1400 may then proceed to act 1418, where it is determined whether the blind spot is still present, as described above. In this way, monitoring of the blind spot by the off-robot sensor(s) may continue until it is determined in act 1418 that the blind spot is no longer present.

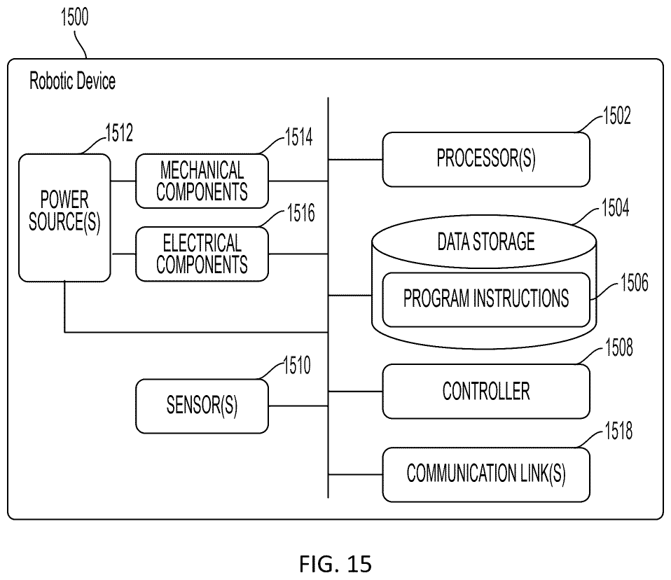

FIG. 15 illustrates an example configuration of a robotic device (or “robot”) 1500, according to an illustrative embodiment of the invention. The robotic device 1500 represents an example robotic device configured to perform the operations described herein. Additionally, the robotic device 1500 may be configured to operate autonomously, semi-autonomously, and/or using directions provided by user(s), and may exist in various forms, such as a humanoid robot, biped, quadruped, or other mobile robot, among other examples. Furthermore, the robotic device 1500 may also be referred to as a robotic system, mobile robot, or robot, among other designations.

As shown in FIG. 15, the robotic device 1500 includes processor(s) 1502, data storage 1504, program instructions 1506, controller 1508, sensor(s) 1510, power source(s) 1512, mechanical components 1514, and electrical components 1516. The robotic device 1500 is shown for illustration purposes and may include more or fewer components without departing from the scope of the disclosure herein. The various components of robotic device 1500 may be connected in any manner, including via electronic communication means, e.g., wired or wireless connections. Further, in some examples, components of the robotic device 1500 may be positioned on multiple distinct physical entities rather on a single physical entity. Other example illustrations of robotic device 1500 may exist as well.

Processor(s) 1502 may operate as one or more general-purpose processor or special purpose processors (e.g., digital signal processors, application specific integrated circuits, etc.). The processor(s) 1502 can be configured to execute computer-readable program instructions 1506 that are stored in the data storage 1504 and are executable to provide the operations of the robotic device 1500 described herein. For instance, the program instructions 1506 may be executable to provide operations of controller 1508, where the controller 1508 may be configured to cause activation and/or deactivation of the mechanical components 1514 and the electrical components 1516. The processor(s) 1502 may operate and enable the robotic device 1500 to perform various functions, including the functions described herein.

The data storage 1504 may exist as various types of storage media, such as a memory. For example, the data storage 1504 may include or take the form of one or more computer-readable storage media that can be read or accessed by processor(s) 1502. The one or more computer-readable storage media can include volatile and/or non-volatile storage components, such as optical, magnetic, organic or other memory or disc storage, which can be integrated in whole or in part with processor(s) 1502. In some implementations, the data storage 1504 can be implemented using a single physical device (e.g., one optical, magnetic, organic or other memory or disc storage unit), while in other implementations, the data storage 1504 can be implemented using two or more physical devices, which may communicate electronically (e.g., via wired or wireless communication). Further, in addition to the computer-readable program instructions 1506, the data storage 1504 may include additional data such as diagnostic data, among other possibilities.

The robotic device 1500 may include at least one controller 1508, which may interface with the robotic device 1500. The controller 1508 may serve as a link between portions of the robotic device 1500, such as a link between mechanical components 1514 and/or electrical components 1516. In some instances, the controller 1508 may serve as an interface between the robotic device 1500 and another computing device. Furthermore, the controller 1508 may serve as an interface between the robotic device 1500 and a user(s). The controller 1508 may include various components for communicating with the robotic device 1500, including one or more joysticks or buttons, among other features. The controller 1508 may perform other operations for the robotic device 1500 as well. Other examples of controllers may exist as well.

Additionally, the robotic device 1500 includes one or more sensor(s) 1510 such as force sensors, proximity sensors, motion sensors, load sensors, position sensors, touch sensors, depth sensors, ultrasonic range sensors, and/or infrared sensors, among other possibilities. The sensor(s) 1510 may provide sensor data to the processor(s) 1502 to allow for appropriate interaction of the robotic device 1500 with the environment as well as monitoring of operation of the systems of the robotic device 1500. The sensor data may be used in evaluation of various factors for activation and deactivation of mechanical components 1514 and electrical components 1516 by controller 1508 and/or a computing system of the robotic device 1500.

The sensor(s) 1510 may provide information indicative of the environment of the robotic device for the controller 1508 and/or computing system to use to determine operations for the robotic device 1500. For example, the sensor(s) 1510 may capture data corresponding to the terrain of the environment or location of nearby objects, which may assist with environment recognition and navigation, etc. In an example configuration, the robotic device 1500 may include a sensor system that may include a camera, RADAR, LIDAR, time-of-flight camera, global positioning system (GPS) transceiver, and/or other sensors for capturing information of the environment of the robotic device 1500. The sensor(s) 1510 may monitor the environment in real-time and detect obstacles, elements of the terrain, weather conditions, temperature, and/or other parameters of the environment for the robotic device 1500.

Further, the robotic device 1500 may include other sensor(s) 1510 configured to receive information indicative of the state of the robotic device 1500, including sensor(s) 1510 that may monitor the state of the various components of the robotic device 1500. The sensor(s) 1510 may measure activity of systems of the robotic device 1500 and receive information based on the operation of the various features of the robotic device 1500, such the operation of extendable legs, arms, or other mechanical and/or electrical features of the robotic device 1500. The sensor data provided by the sensors may enable the computing system of the robotic device 1500 to determine errors in operation as well as monitor overall functioning of components of the robotic device 1500.

For example, the computing system may use sensor data to determine the stability of the robotic device 1500 during operations as well as measurements related to power levels, communication activities, components that require repair, among other information. As an example configuration, the robotic device 1500 may include gyroscope(s), accelerometer(s), and/or other possible sensors to provide sensor data relating to the state of operation of the robotic device. Further, sensor(s) 1510 may also monitor the current state of a function that the robotic device 1500 may currently be operating. Additionally, the sensor(s) 1510 may measure a distance between a given robotic limb of a robotic device and a center of mass of the robotic device. Other example uses for the sensor(s) 1510 may exist as well.

Additionally, the robotic device 1500 may also include one or more power source(s) 1512 configured to supply power to various components of the robotic device 1500. Among possible power systems, the robotic device 1500 may include a hydraulic system, electrical system, batteries, and/or other types of power systems. As an example illustration, the robotic device 1500 may include one or more batteries configured to provide power to components via a wired and/or wireless connection. Within examples, components of the mechanical components 1514 and electrical components 1516 may each connect to a different power source or may be powered by the same power source. Components of the robotic device 1500 may connect to multiple power sources as well.

Within example configurations, any type of power source may be used to power the robotic device 1500, such as a gasoline and/or electric engine. Further, the power source(s) 1512 may charge using various types of charging, such as wired connections to an outside power source, wireless charging, combustion, or other examples. Other configurations may also be possible. Additionally, the robotic device 1500 may include a hydraulic system configured to provide power to the mechanical components 1514 using fluid power. Components of the robotic device 1500 may operate based on hydraulic fluid being transmitted throughout the hydraulic system to various hydraulic motors and hydraulic cylinders, for example. The hydraulic system of the robotic device 1500 may transfer a large amount of power through small tubes, flexible hoses, or other links between components of the robotic device 1500. Other power sources may be included within the robotic device 1500.

Mechanical components 1514 can represent hardware of the robotic device 1500 that may enable the robotic device 1500 to operate and perform physical functions. As a few examples, the robotic device 1500 may include actuator(s), extendable leg(s), arm(s), wheel(s), one or multiple structured bodies for housing the computing system or other components, and/or other mechanical components. The mechanical components 1514 may depend on the design of the robotic device 1500 and may also be based on the functions and/or tasks the robotic device 1500 may be configured to perform. As such, depending on the operation and functions of the robotic device 1500, different mechanical components 1514 may be available for the robotic device 1500 to utilize. In some examples, the robotic device 1500 may be configured to add and/or remove mechanical components 1514, which may involve assistance from a user and/or other robotic device.

The electrical components 1516 may include various components capable of processing, transferring, providing electrical charge or electric signals, for example. Among possible examples, the electrical components 1516 may include electrical wires, circuitry, and/or wireless communication transmitters and receivers to enable operations of the robotic device 1500. The electrical components 1516 may interwork with the mechanical components 1514 to enable the robotic device 1500 to perform various operations. The electrical components 1516 may be configured to provide power from the power source(s) 1512 to the various mechanical components 1514, for example. Further, the robotic device 1500 may include electric motors. Other examples of electrical components 1516 may exist as well.

In some implementations, the robotic device 1500 may also include communication link(s) 1518 configured to send and/or receive information. The communication link(s) 1518 may transmit data indicating the state of the various components of the robotic device 1500. For example, information read in by sensor(s) 1510 may be transmitted via the communication link(s) 1518 to a separate device. Other diagnostic information indicating the integrity or health of the power source(s) 1512, mechanical components 1514, electrical components 1516, processor(s) 1502, data storage 1504, and/or controller 1508 may be transmitted via the communication link(s) 1518 to an external communication device.

In some implementations, the robotic device 1500 may receive information at the communication link(s) 1518 that is processed by the processor(s) 1502. The received information may indicate data that is accessible by the processor(s) 1502 during execution of the program instructions 1506, for example. Further, the received information may change aspects of the controller 1508 that may affect the behavior of the mechanical components 1514 or the electrical components 1516. In some cases, the received information indicates a query requesting a particular piece of information (e.g., the operational state of one or more of the components of the robotic device 1500), and the processor(s) 1502 may subsequently transmit that particular piece of information back out the communication link(s) 1518.

In some cases, the communication link(s) 1518 include a wired connection. The robotic device 1500 may include one or more ports to interface the communication link(s) 1518 to an external device. The communication link(s) 1518 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

A number of implementations have been described. Nevertheless, it will be understood that various modifications may be made without departing from the spirit and scope of the disclosure.

1. An access point device, comprising:
a network interface configured to be coupled to a wired network;
a radio configured to emit radio waves that enable a plurality of wireless devices in an environment of the access point device to wirelessly access the wired network; and
at least one signaling component, wherein the at least one signaling component is configured to transmit and/or receive signals, wherein the signals are different from the radio waves emitted from the radio.

2. The access point device of claim 1, wherein the environment is a warehouse, and the access point device is configured as a node in a wireless local area network within the warehouse.

3. The access point device of claim 2, wherein the plurality of wireless devices include a plurality of mobile robots operating within the warehouse.

4. The access point device of claim 3, wherein the plurality of mobile robots include a first mobile robot configured to grasp and place objects in the environment.

5. (canceled)

6. The access point device of claim 1, wherein the at least one signaling component includes a radio-frequency component configured to transmit and/or receive the signals.

7. (canceled)

8. The access point device of claim 1, wherein the at least one signaling component includes a RADAR system and/or a LIDAR system configured to sense a presence of mobile objects in the environment.

9. The access point device of claim 1, wherein the at least one signaling component includes a camera module configured to capture information in the environment of the access point device.

10. (canceled)

11. The access point device of claim 1, wherein the at least one signaling component includes a microphone configured to detect sound waves emitted by one or more objects in the environment.

12. The access point device of claim 1, further comprising at least one computer processor programmed to:
process at least some of the signals received by the at least one signaling component to detect and/or identify one or more objects in the environment.

13. (canceled)

14. The access point device of claim 12, wherein detecting one or more objects in the environment comprises detecting motion of one or more objects in the environment.

15. The access point device of claim 12, wherein
the at least one signaling component includes a plurality of signaling components, and
the at least one computer processor is further programmed to detect and/or identify the one or more objects in the environment based, at least in part, on signals from multiple of the plurality of signaling components.

16. The access point device of claim 12, wherein the one or more objects detected and/or identified in the environment includes a mobile agent.

17. The access point device of claim 16, wherein the mobile agent is a human or a mobile robot.

18. The access point device of claim 16, wherein the at least one computer processor is further programmed to send a signal to a central processor in response to detecting and/or identifying the one or more objects in the environment, the central processor configured to facilitate control of an operation of the mobile agent.

19. The access point device of claim 18, wherein the mobile agent is a mobile robot, and wherein the central processor is configured to facilitate control of an operation of the mobile robot.

20. (canceled)

21. The access point device of claim 1, wherein the at least one signaling component includes a light source.

22. The access point device of claim 21, wherein the light source is configured to transmit a light pattern into the environment and/or blink according to a particular pattern.

23. (canceled)

24. The access point device of claim 1, wherein the at least one signaling component includes an audio source configured to output audio into the environment.

25. The access point device of claim 1, wherein transmitting and/or receiving signals comprises transmitting and/or receiving data using the signals.

26. A method of operating an access point device, the method comprising:
controlling the access point device to emit radio waves that enable a plurality of wireless devices in an environment of the access point device to wirelessly access a wired network coupled to the access point device;
receiving, by at least one signaling component, signals from one or more objects in the environment;
processing the received signals to detect and/or identify the one or more objects in the environment; and
sending a signal to a processor in response to detecting and/or identifying the one or more objects in the environment, the processor configured to facilitate control of an operation of at least one mobile robot in the environment.

27.-132. (canceled)
